(19) United States
(12) Patent Application Publication
(10) Pub. No.: US 2025/0183025 A1
(43) Pub. Date: Jun. 5, 2025

(54) ELECTROSPRAY EMITTER DEVICES AND METHODS OF USE THEREOF

(71) Applicant: Ohio State Innovation Foundation, Columbus, OH (US)

(72) Inventors: Abraham BADU-TAWIAH, Columbus, OH (US); Alex GROOMS, Columbus, OH (US); Derik HEISS, Plain City, OH (US); Bejamin BURRIS, Columbus, OH (US); Dmytro KULYK, Columbus, OH (US)

(21) Appl. No.: 18/846,152

(22) PCT Filed: Jan. 11, 2023
(86) PCT No.: PCT/US2023/060453

§ 371 Date: Sep. 11, 2024

Related U.S. Application Data
(60) Provisional application No. 63/319,166, filed on Mar. 11, 2022.
(60) Provisional application No. 63/411,185, filed on Sep. 29, 2022.

(51) Int. Cl. H01J 49/16; H01J 49/00

(52) U.S. Cl. CPC H01J 49/167; H01J 49/0031

(57) ABSTRACT

Disclosed herein are electrospray emitter devices for delivering a fluid sample to a mass spectrometer, the emitter devices comprising a sample capillary extending from a sample inlet to a sample outlet said sample capillary defining a path for fluid flow from the sample inlet to the sample outlet. The sample Inlet is configured to receive a fluid sample, the fluid sample being an eluent from a liquid chromatograph. A reagent capillary extending from a reagent inlet to a reagent outlet, the reagent capillary defining a path for fluid flow from the reagent inlet to the reagent outlet. A first conduit disposed around a first portion of the sample capillary and a first portion of the reagent capillary; the first conduit comprises a wall defining a lumen, the first conduit extends from a first end to a second end opposite and axially spaced apart from the first end.

### CROSS-REFERENCE TO RELATED APPLICATIONS

This application claims the benefit of priority to U.S. Provisional Application No. 63/319,166 filed Mar. 11, 2022 and U.S. Provisional Application No. 63/411,185 filed Sep. 29, 2022, each of which is hereby incorporated herein by reference in its entirety.

### STATEMENT OF GOVERNMENT SUPPORT

This invention was made with government support under grant/contract number 1900271 awarded by the National Science Foundation and grant/contract no. DE-SC0022097 awarded by the Department of Energy. The government has certain rights in the invention.

### BACKGROUND

Despite the abundance of advanced instrumentation available today, there is still no single, universal technique that can be applied to all analytical problems. Ultimately, the characteristics of the sample and physicochemical properties of the analyte of interest must be reconciled with the limitations of the chosen analytical finish. Recent developments have transformed mass spectrometry (MS) into an all-purpose technique for in-situ and real-time chemical analysis, but quantitative mass spectrometry is beset with challenges posed by ion suppression effects due to the presence of endogenous or exogenous matrices. Improved methods and devices are needed. The devices and methods discussed herein address these and other needs.

### SUMMARY

In accordance with the purposes of the disclosed devices and methods as embodied and broadly described herein, the disclosed subject matter relates to electrospray emitter devices and methods of use thereof.

For example, disclosed herein are electrospray emitter devices comprising a sample capillary extending from a sample inlet to a sample outlet said sample capillary defining a path for fluid flow from the sample inlet to the sample outlet. In some examples, the sample inlet is configured to receive a fluid sample, the fluid sample being an eluent from a liquid chromatograph. In some examples, the electrospray emitter device further comprises a reagent capillary extending from a reagent inlet to a reagent outlet, the reagent capillary defining a path for fluid flow from the reagent inlet to the reagent outlet. In some examples, the reagent inlet is configured to receive a fluid reagent. In some examples, the electrospray emitter device further comprises a voltage source conductively coupled to the reagent capillary and configured to apply a voltage to the reagent capillary. In some examples, the electrospray emitter device further comprises a first conduit disposed around a first portion of the sample capillary and a first portion of the reagent capillary. In some examples, the first conduit comprises a wall defining a lumen, the first conduit extends from a first end to a second end opposite and axially spaced apart from the first end, and the lumen defines a path for fluid flow. In some examples, the electrospray emitter device further comprises a carrier gas inlet fluidly connected to the lumen, the carrier gas inlet being configured to receive a carrier gas. In some examples, the sample outlet and the reagent outlet each extend beyond the second end of the first conduit such that the sample outlet and the reagent outlet are each disposed outside of the first conduit.

In some examples, the carrier gas inlet is integrally formed with the first conduit. In some examples, the electrospray emitter device further comprises a carrier gas source fluidly connected to the carrier gas inlet.

In some examples, the electrospray emitter device further comprises a first fitting disposed within the lumen of the first conduit towards the first end, the first fitting being coaxial with the first conduit. In some examples, the first fitting is fluid tight and has a one or more ports configured to receive the sample capillary and the reagent capillary, such that the sample capillary and the reagent capillary each penetrate through the first fitting. In some examples, the first fitting comprises a first port configured to receive the sample capillary and a second port configured to receive the reagent capillary.

In some examples, the electrospray emitter device further comprises a second conduit disposed around a second portion of the sample capillary and a second portion of the reagent capillary. In some examples, the second conduit comprises a wall defining a lumen; the second conduit extends from a proximal end to a distal end opposite and axially spaced apart from the proximal end; and the lumen defines a path for fluid flow terminating in a gas outlet at the distal end. In some examples, the proximal end of the second conduit is disposed within the lumen of the first conduit and the distal end of the second conduit extends beyond the second end of the first conduit, such that the first conduit is disposed around a portion of the second conduit and the distal end of the second conduit is disposed outside of the first conduit. In some examples, the sample outlet and the reagent outlet each extend beyond the distal end of the second conduit such that the sample outlet and the reagent outlet are each disposed outside of the second conduit.

In some examples, the electrospray emitter device further comprises a second fitting disposed within the lumen of the first conduit towards the second end, the second fitting being coaxial with the first conduit. In some examples, the second fitting having an orifice configured to receive the second conduit such that the second conduit penetrates through the second fitting and the second fitting is disposed around a portion of the second conduit. In some examples, the second fitting forms a fluid tight seal extending between the first conduit and the second conduit.

Also disclosed herein are electrospray emitter devices comprising: a sample capillary extending from a sample inlet to a sample outlet, said sample capillary defining a path for fluid flow from the sample inlet to the sample outlet; wherein the sample inlet is configured to receive a fluid sample, the fluid sample being an eluent from a liquid chromatograph; a reagent capillary extending from a reagent inlet to a reagent outlet, the reagent capillary defining a path for fluid flow from the reagent inlet to the reagent outlet; wherein the reagent inlet is configured to receive a fluid reagent; a voltage source conductively coupled to the reagent capillary and configured to apply a voltage to the reagent capillary; a first conduit disposed around a first portion of the sample capillary and a first portion of the reagent capillary; the first conduit comprising a wall defining a lumen; the first conduit extending from a first end to a second end opposite and axially spaced apart from the first end; the lumen defining a path for fluid flow; a carrier gas inlet fluidly connected to the lumen, the carrier gas inlet being configured to receive a carrier gas; a second conduit disposed around a second portion of the sample capillary and a second portion of the reagent capillary; the second conduit comprising a wall defining a lumen; the second conduit extending from a proximal end to a distal end opposite and axially spaced apart from the proximal end; the lumen defining a path for fluid flow terminating in a gas outlet at the distal end; wherein the proximal end of the second conduit is disposed within the lumen of the first conduit and the distal end of the second conduit extends beyond the second end of the first conduit, such that the first conduit is disposed around a portion of the second conduit and the distal end of the second conduit is disposed outside of the first conduit; wherein the sample outlet and the reagent outlet each extend beyond the distal end of the second conduit such that the sample outlet and the reagent outlet are each disposed outside of the second conduit; a first fitting disposed within the lumen of the first conduit towards the first end, the first fitting being coaxial with the first conduit; the first fitting being fluid tight and having a one or more ports configured to receive the sample capillary and the reagent capillary, such that the sample capillary and the reagent capillary each penetrate through the first fitting; a second fitting disposed within the lumen of the first conduit towards the second end, the second fitting being coaxial with the first conduit; the second fitting having an orifice configured to receive the second conduit such that the second conduit penetrates through the second fitting and the second fitting is disposed around a portion of the second conduit; and wherein the second fitting forms a fluid tight seal extending between the first conduit and the second conduit. In some examples, the first fitting comprises a first port configured to receive the sample capillary and a second port configured to receive the reagent capillary.

In some examples, the electrospray emitter devices further comprise a liquid chromatograph fluidly coupled to the sample inlet, such that the liquid chromatograph is configured to inject the fluid sample into the sample inlet.

In some examples, the sample capillary comprises a section disposed between the sample inlet and the first end of the first conduit, and said section being grounded. In some examples, the section is conductively coupled to a ground source. In some examples, the section comprises PEEK.

In some examples, the sample capillary has an average internal diameter of from 50 microns to 200 microns. In some examples, the sample capillary has an average internal diameter of 100 microns.

In some examples, the sample capillary comprises fused silica.

In some examples, the reagent inlet is fluidly coupled to a reagent source.

In some examples, the electrospray emitter device further comprises a pump fluidly connected to the reagent source and the reagent inlet, the pump being configured to inject the fluid reagent into the reagent inlet.

In some examples, the reagent capillary has an average internal diameter of from 50 microns to 200 microns. In some examples, the reagent capillary has an average internal diameter of 100 microns.

In some examples, the reagent capillary comprises fused silica.

In some examples, the first conduit comprises stainless steel.

In some examples, the second conduit has an average internal diameter of from 200 microns to 1000 microns. In some examples, the second conduit has an average internal diameter of 450 microns.

In some examples, the second conduit comprises fused silica.

In some examples, the electrospray emitter device further comprises an analyzer positioned to receive an electrosprayed sample from the sample outlet and the reagent outlet. In some examples, the analyzer comprises a mass spectrometer.

Also disclosed herein are methods of use of any of the electrospray emitter devices disclosed herein, the methods comprising injecting a fluid sample into the sample inlet and injecting a fluid reagent into the reagent inlet. In some examples, the methods further comprise forming a droplet of the fluid sample at the sample outlet and forming a droplet of the fluid reagent at the reagent outlet. In some examples, the methods further comprise injecting a carrier gas into the carrier gas inlet, thereby contacting the droplet of the fluid sample and the droplet of the fluid reagent with the carrier gas. In some examples, the methods further comprise ejecting the droplet of the fluid sample from the sample outlet and ejecting the droplet of the fluid reagent from the reagent outlet.

In some examples, the fluid sample comprises a solvent and an analyte.

In some examples, the solvent comprises acetonitrile, water, or a combination thereof.

In some examples, the fluid sample comprises a bodily fluid, such as urine, plasma, or a combination thereof. In some examples, the bodily fluid comprises a saccharide, a lipid, a fatty acid, a steroid, a protein, a nucleic acid, or a combination thereof.

In some examples, the analyte comprises a saccharide, a lipid, a fatty acid, a steroid, a protein, a nucleic acid, or a combination thereof.

In some examples, the fluid sample is injected at a flow rate of from 1 μL/minute to 100 μL/minute. In some examples, the fluid sample is injected at a flow rate of 75 μL/minute.

In some examples, the fluid sample is injected from a liquid chromatograph.

In some examples, the carrier gas comprises nitrogen.

In some examples, the carrier gas is injected at a pressure of from 0 to 150 psi.

In some examples, the voltage applied to the reagent capillary is from 0 kV to 10 kV. In some examples, the voltage applied to the reagent capillary is 6.5 kV.

In some examples, ejecting the droplets comprises adjusting a pressure at which the carrier gas is injected, adjusting a flow rate at which the fluid sample is injected, adjusting the flow rate at which the fluid reagent is injected, adjusting the voltage applied to the sample capillary, or a combination thereof.

In some examples, the fluid reagent is injected at a flow rate of from 1 μL/minute to 20 μL/minute. In some examples, the fluid reagent is injected at a flow rate of 5 μL/minute.

In some examples, the fluid reagent comprises a solvent and a reagent.

In some examples, the solvent comprises acetonitrile, water, or a combination thereof.

In some examples, the reagent has a concentration of from greater than 0 mM to 100 mM. In some examples, the reagent has a concentration of 4 mM.

In some examples, the ejected droplet of the fluid sample comprises an ionized form of the analyte.

In some examples, the ejected droplet of the fluid reagent comprises an ionized form of the reagent.

In some examples, the ejected droplet of the fluid sample contacts and reacts with the ejected droplet of the fluid reagent, thereby forming one or more droplets comprising a reacted sample.

In some examples, the ejected droplet of the fluid sample and the ejected droplet of the fluid reagent form a single Taylor cone.

In some examples, the reagent comprises a derivatization reagent, a hydrolysis reagent, a catalytic reagent, a crosslinking reagent, an adduct forming reagent, or a combination thereof.

In some examples, the reacted sample comprises a derivatized form of the analyte.

In some examples, the reaction is achieved on a timescale similar to electrospray microdroplet lifetimes.

In some examples, the reaction is achieved in an amount of time from 1 microsecond to 1 minute. In some examples, the reaction is achieved in an amount of time from 1 microsecond to 30 seconds, or from 1 microsecond to 10 seconds.

In some examples, the methods further comprise collecting one or more of the one or more droplets comprising the reacted sample.

In some examples, the methods further comprise injecting one or more of the one or more droplets comprising the reacted sample into an analyzer. In some examples, the analyzer comprises a mass spectrometer.

Additional advantages of the disclosed devices and methods will be set forth in part in the description which follows, and in part will be obvious from the description. The advantages of the disclosed devices and methods will be realized and attained by means of the elements and combinations particularly pointed out in the appended claims. It is to be understood that both the foregoing general description and the following detailed description are exemplary and explanatory only and are not restrictive of the disclosed devices and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. Schematic view of an example electrospray emitter device as disclosed herein according to one implementation.

FIG. 2. Schematic view of an example electrospray emitter device as disclosed herein according to one implementation.

FIG. 3. Schematic view of an example electrospray emitter device as disclosed herein according to one implementation.

FIG. 4. Schematic view of an example electrospray emitter device as disclosed herein according to one implementation.

FIG. 5. A schematic representation of the dual-feed coaxial contained-electrospray ion source customized to facilitate in-source derivatization and ionization of analytes as they elute from an HPLC column.

FIG. 6. Representative LC-contained-ESI-MS/MS chromatograms for a mix of the seven test sugars generated using in-source droplet-based phenylboronic acid derivatization. For the monosaccharides fructose and glucose, the disubstituted PBA derivative is formed in the ion source (2PBA), while for the remaining sugars, the monosubstituted derivatives are generated (PBA).

FIG. 7A. Three oligosaccharides.

FIG. 7B. Chromatograms for the three oligosaccharides spiked at 10×LOQ into human urine. The black traces represent the urine samples spiked at a 10×LOQ concentration while the red traces represent the blank, unspiked controls.

FIG. 7C. Chromatograms for three oligosaccharides spiked at 10×LOQ into human plasma. The black traces represent the plasma samples spiked at a 10×LOQ concentration while the red traces represent the blank, unspiked controls.

FIG. 8A. Image showing the LC-contained-ESI-MS setup. The LC eluent exits the column and passes through a grounded connector before entering the contained-ESI source. The derivatization reagent (PBA) is delivered coaxially to the contained-ESI source by a syringe pump. Voltage is applied to the reagent stream using an alligator clip connected to the stainless-steel needle of the reagent syringe to generate electrospray.

FIG. 8B. Image of the contained-electrospray ion source showing coaxial introduction of the HPLC eluent and reagent streams.

FIG. 8C. The inner capillaries containing the eluent and reagent streams both extend ˜1 mm beyond the outer capillary and converge at the tip of the emitter.

FIG. 9A. MS/MS spectrum for the PBA derivatives of glucose. Spectrum was acquired using the contained-ESI source under the optimized source conditions shown in Table TA-Table 1D by infusing 100 μM solutions of the sugar into the source at 10 μL/min while coaxially delivering the PBA reagent.

FIG. 9B. MS/MS spectrum for the PBA derivatives of fructose. Spectrum was acquired using the contained-ESI source under the optimized source conditions shown in Table 1A-Table 1D by infusing 100 μM solutions of the sugar into the source at 10 μL/min while coaxially delivering the PBA reagent.

FIG. 9C. MS/MS spectrum for the PBA derivatives of lactose. Spectrum was acquired using the contained-ESI source under the optimized source conditions shown in Table 1A-Table 1D by infusing 100 μM solutions of the sugar into the source at 10 μL/min while coaxially delivering the PBA reagent.

FIG. 9D. MS/MS spectrum for the PBA derivatives of sucrose. Spectrum was acquired using the contained-ESI source under the optimized source conditions shown in Table 1A-Table 1D by infusing 100 μM solutions of the sugar into the source at 10 μL/min while coaxially delivering the PBA reagent.

FIG. 9E. MS/MS spectrum for the PBA derivatives of raffinose. Spectrum was acquired using the contained-ESI source under the optimized source conditions shown in Table 1A-Table 1D by infusing 100 μM solutions of the sugar into the source at 10 μL/min while coaxially delivering the PBA reagent.

FIG. 9F. MS/MS spectrum for the PBA derivatives of glucose tetrasaccharide. Spectrum was acquired using the contained-ESI source under the optimized source conditions shown in Table 1A-Table 1D by infusing 100 μM solutions of the sugar into the source at 10 μL/min while coaxially delivering the PBA reagent.

FIG. 9G. MS/MS spectrum for the PBA derivatives of maltopentaose. Spectrum was acquired using the contained-ESI source under the optimized source conditions shown in Table 1A-Table 1D by infusing 100 μM solutions of the sugar into the source at 10 μL/min while coaxially delivering the PBA reagent.

FIG. 10A. Mass spectrum showing the products of PBA derivatization for glucose showing the formation of the monosubstituted phenylboronate esters (M/PBA) and hydroxylated phenylboronate esters (M/PBA+OH), as well as the disubstituted bis(phenylboronate) esters (M/2PBA). Spectrum was acquired using the contained-ESI source under the optimized source conditions shown in Table 1A-Table 1D by infusing 100 μM solutions of the sugar into the source at 10 μL/min while coaxially delivering the PBA reagent. Peaks attributed to the reagent or background chemical noise are denoted by (*).

FIG. 10B. Mass spectrum showing the products of PBA derivatization for fructose showing the formation of the monosubstituted phenylboronate esters (M/PBA) and hydroxylated phenylboronate esters (M/PBA+OH), as well as the disubstituted bis(phenylboronate) esters (M/2PBA). Spectrum was acquired using the contained-ESI source under the optimized source conditions shown in Table 1A-Table 1D by infusing 100 μM solutions of the sugar into the source at 10 μL/min while coaxially delivering the PBA reagent. Peaks attributed to the reagent or background chemical noise are denoted by (*).

FIG. 10C. Mass spectrum showing the products of PBA derivatization for lactose showing the formation of the monosubstituted phenylboronate esters (M/PBA) and hydroxylated phenylboronate esters (M/PBA+OH), as well as the disubstituted bis(phenylboronate) esters (M/2PBA). Spectrum was acquired using the contained-ESI source under the optimized source conditions shown in Table 1A-Table 1D by infusing 100 μM solutions of the sugar into the source at 10 μL/min while coaxially delivering the PBA reagent. Peaks attributed to the reagent or background chemical noise are denoted by (*).

FIG. 10D. Mass spectrum showing the products of PBA derivatization for sucrose showing the formation of the monosubstituted phenylboronate esters (M/PBA) and hydroxylated phenylboronate esters (M/PBA+OH), as well as the disubstituted bis(phenylboronate) esters (M/2PBA). Spectrum was acquired using the contained-ESI source under the optimized source conditions shown in Table 1A-Table 1D by infusing 100 μM solutions of the sugar into the source at 10 μL/min while coaxially delivering the PBA reagent. Peaks attributed to the reagent or background chemical noise are denoted by (*).

FIG. 10E. Mass spectrum showing the products of PBA derivatization for raffinose showing the formation of the monosubstituted phenylboronate esters (M/PBA) and hydroxylated phenylboronate esters (M/PBA+OH), as well as the disubstituted bis(phenylboronate) esters (M/2PBA). Spectrum was acquired using the contained-ESI source under the optimized source conditions shown in Table 1A-Table 1D by infusing 100 μM solutions of the sugar into the source at 10 μL/min while coaxially delivering the PBA reagent. Peaks attributed to the reagent or background chemical noise are denoted by (*).

FIG. 10F. Mass spectrum showing the products of PBA derivatization for glucose tetrasaccharide showing the formation of the monosubstituted phenylboronate esters (M/PBA) and hydroxylated phenylboronate esters (M/PBA+OH), as well as the disubstituted bis(phenylboronate) esters (M/2PBA). Spectrum was acquired using the contained-ESI source under the optimized source conditions shown in Table 1A-Table 1D by infusing 100 μM solutions of the sugar into the source at 10 μL/min while coaxially delivering the PBA reagent. Peaks attributed to the reagent or background chemical noise are denoted by (*).

FIG. 10G. Mass spectrum showing the products of PBA derivatization for maltopentaose showing the formation of the monosubstituted phenylboronate esters (M/PBA) and hydroxylated phenylboronate esters (M/PBA+OH), as well as the disubstituted bis(phenylboronate) esters (M/2PBA). Spectrum was acquired using the contained-ESI source under the optimized source conditions shown in Table 1A-Table 1D by infusing 100 μM solutions of the sugar into the source at 10 μL/min while coaxially delivering the PBA reagent. Peaks attributed to the reagent or background chemical noise are denoted by (*).

FIG. 11. Determination of optimal reagent concentration for the in-source reaction of phenylboronic acid with the seven test sugars using contained-electrospray. A 10 μM sugar mixture was injected using the optimized method parameters shown in Table 1A-Table ID except for the reagent concentration, which was varied. Triplicate injections were performed for each reagent concentration. Peak areas were recorded, normalized, and plotted.

FIG. 12. Determination of optimal flow rate for delivery of the derivatization reagent (PBA) during in-source reaction of phenylboronic acid with the test sugars. A 10 μM sugar mixture was injected using the optimized method parameters shown in Table 1A-Table ID except for the reagent flow rate, which was varied. Triplicate injections were performed at each flow rate. Peak areas were recorded, normalized, and plotted.

FIG. 13A. LC-contained-ESI-MS/MS calibration curve for the PBA-derivatives of fructose. Data were generated using the method parameters listed in Table 1A-Table ID.

FIG. 13B. LC-contained-ESI-MS/MS calibration curve for the PBA-derivatives of glucose. Data were generated using the method parameters listed in Table 1A-Table ID.

FIG. 13C. LC-contained-ESI-MS/MS calibration curve for the PBA-derivatives of sucrose. Data were generated using the method parameters listed in Table 1A-Table ID.

FIG. 13D. LC-contained-ESI-MS/MS calibration curve for the PBA-derivatives of lactose. Data were generated using the method parameters listed in Table 1A-Table ID.

FIG. 13E. LC-contained-ESI-MS/MS calibration curve for the PBA-derivatives of raffinose. Data were generated using the method parameters listed in Table 1A-Table ID.

FIG. 13F. LC-contained-ESI-MS/MS calibration curve for the PBA-derivatives of glucose tetrasaccharide. Data were generated using the method parameters listed in Table 1A-Table 1D.

FIG. 13G. LC-contained-ESI-MS/MS calibration curve for the PBA-derivatives of maltopentaose. Data were generated using the method parameters listed in Table 1A-Table ID.

FIG. 14. Chromatograms representing a 1×LOQ calibration standard in 80:20 acetonitrile:water. Data were acquired using the method parameters in Table 1A-Table 1D. Individual LOQ concentrations are included in Table 3.

FIG. 15. Example data for glucose and fructose used to calculate k and Rs shown in Table 2.

FIG. 16. LC-MS with on-the-fly microdroplet derivatization.

### DETAILED DESCRIPTION

The devices and methods described herein may be understood more readily by reference to the following detailed description of specific aspects of the disclosed subject matter and the Examples included therein.

Before the present devices and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

As used herein, by a “subject” is meant an individual. Thus, the “subject” can include domesticated animals (e.g., cats, dogs, etc.), livestock (e.g., cattle, horses, pigs, sheep, goats, etc.), laboratory animals (e.g., mouse, rabbit, rat, guinea pig, etc.), and birds. “Subject” can also include a mammal, such as a primate or a human. Thus, the subject can be a human or veterinary patient. The term “patient” refers to a subject under the treatment of a clinician, e.g., physician.

### Devices

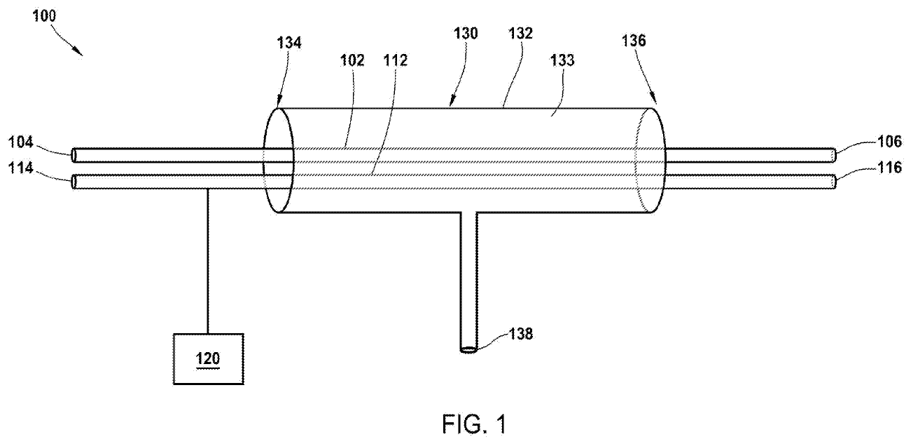

Disclosed herein are electrospray emitter devices. Referring now to FIG. 1, in some examples, the electrospray emitter device 100 comprise a sample capillary 102 extending from a sample inlet 104 to a sample outlet 106, said sample capillary 102 defining a path for fluid flow from the sample inlet 104 to the sample outlet 106.

The sample capillary 102 can be fabricated from any suitable material or combination of materials compatible with the devices and methods described herein. Examples of suitable materials can include polymers, silicones, glasses, metals, ceramics, inorganic materials, and combinations thereof. In some examples, the sample capillary 102 is formed from a conductive material. Examples of suitable conductive materials can include conductive polymers, conductive silicones, conductive glasses, metals, conductive ceramics, conductive inorganic materials, and combinations thereof. In some examples, the sample capillary 102 can be formed from a conductive transparent material. In some examples, the sample capillary 102 can be formed from fused silica.

The sample capillary 102 can have any suitable dimensions. In some examples, the sample capillary 102 has an average internal diameter of 50 micrometers (microns) or more (e.g., 60 microns or more, 70 microns or more, 80 microns or more, 90 microns or more, 100 microns or more, 110 microns or more, 120 microns or more, 130 microns or more, 140 microns or more, 150 microns or more, 160 microns or more, 170 microns or more, 180 microns or more, or 190 microns or more). In some examples, the sample capillary 102 has an average internal diameter of 200 microns or less (e.g., 190 microns or less, 180 microns or less, 170 microns or less, 160 microns or less, 150 microns or less, 140 microns or less, 130 microns or less, 120 microns or less, 110 microns or less, 100 microns or less, 90 microns or less, 80 microns or less, 70 microns or less, or 60 microns or less). The average internal diameter of the sample capillary 102 can range from any of the minimum values described above to any of the maximum values described above. For example, the sample capillary 102 can have an average internal diameter of from 50 microns to 200 microns (e.g., from 50 to 125 microns, from 125 to 200 microns, from 50 to 100 microns, from 100 to 150 microns, from 150 to 200 microns, from 50 to 180 microns, from 50 to 160 microns, from 50 to 140 microns, from 50 to 120 microns, from 50 to 80 microns, from 60 to 200 microns, from 80 to 200 microns, from 100 to 200 microns, from 120 to 200 microns, from 140 to 200 microns, from 160 to 200 microns, from 60 to 190 microns, from 70 to 180 microns, from 80 to 120 microns, or from 90 to 110 microns). In some examples, the sample capillary 102 has an average internal diameter of 100 microns.

The sample inlet 104 is configured to receive a fluid sample. The fluid sample can, for example, be an eluent from a liquid chromatograph. In some examples, the fluid sample comprises a solvent and an analyte. The solvent can, for example, comprise tetrahydrofuran (THF), N-methyl-2-pyrrolidone (NMP), dimethylformamide (DMF), N-methylformamide, formamide, dichloromethane (CH₂Cl₂), ethylene glycol, polyethylene glycol, glycerol, alkane diol, ethanol, methanol, propanol, isopropanol, water, acetonitrile, chloroform, toluene, methyl acetate, ethyl acetate, acetone, hexane, heptane, tetraglyme, propylene carbonate, diglyme, dimethyl sulfoxide (DMSO), dimethoxyethane, xylene, dimethylacetamide, methylene chloride, hexafluoro-2-propanol, or combinations thereof. In some examples, solvent comprises acetonitrile, water, or a combination thereof.

The fluid sample can comprise any liquid sample of interest. By way of example the fluid sample can comprise a bodily fluid. “Bodily fluid”, as used herein, refers to a fluid composition obtained from or located within a human or animal subject. Bodily fluids include, but are not limited to, urine, whole blood, blood plasma, serum, tears, semen, saliva, sputum, exhaled breath, nasal secretions, pharyngeal exudates, bronchoalveolar lavage, tracheal aspirations, interstitial fluid, lymph fluid, meningeal fluid, amniotic fluid, glandular fluid, feces, perspiration, mucous, vaginal or urethral secretion, cerebrospinal fluid, and transdermal exudate. Bodily fluid also includes experimentally separated fractions of all of the preceding solutions, as well as mixtures containing homogenized solid material, such as feces, tissues, and biopsy samples. In some examples, the fluid sample comprises a bodily fluid, such as urine, plasma, or a combination thereof. In some examples, the bodily fluid comprises a saccharide, a lipid, a fatty acid, a steroid, a protein, or a combination thereof. In some examples, the bodily fluid comprises a saccharide, such as a monosaccharide, a disaccharide, an oligosaccharide, or a combination thereof.

The analyte can comprise any analyte of interest. For example, the analyte can comprise a saccharide, a lipid, a fatty acid, a steroid, a protein, a nucleic acid (e.g., DNA, RNA), or a combination thereof. In some examples, the analyte can comprise a saccharide, such as a monosaccharide, a disaccharide, an oligosaccharide, or a combination thereof.

The electrospray emitter device 100 further comprises a reagent capillary 112 extending from a reagent inlet 114 to a reagent outlet 116, the reagent capillary 112 defining a path for fluid flow from the reagent inlet 114 to the reagent outlet 116.

The reagent capillary 112 can be fabricated from any suitable material or combination of materials compatible with the devices and methods described herein. Examples of suitable materials can include polymers, silicones, glasses, metals, ceramics, inorganic materials, and combinations thereof. In some examples, the reagent capillary 112 is formed from a conductive material. Examples of suitable materials can include conductive polymers, conductive silicones, conductive glasses, metals, conductive ceramics, conductive inorganic materials, and combinations thereof. In some examples, the reagent capillary 112 can be formed from a conductive transparent material. In some examples, the reagent capillary 112 can be formed from fused silica.

The reagent capillary 112 can have any suitable dimensions. In some examples, the reagent capillary 112 has an average internal diameter of 50 micrometers (microns) or more (e.g., 60 microns or more, 70 microns or more, 80 microns or more, 90 microns or more, 100 microns or more, 110 microns or more, 120 microns or more, 130 microns or more, 140 microns or more, 150 microns or more, 160 microns or more, 170 microns or more, 180 microns or more, or 190 microns or more). In some examples, the reagent capillary 112 has an average internal diameter of 200 microns or less (e.g., 190 microns or less, 180 microns or less, 170 microns or less, 160 microns or less, 150 microns or less, 140 microns or less, 130 microns or less, 120 microns or less, 110 microns or less, 100 microns or less, 90 microns or less, 80 microns or less, 70 microns or less, or 60 microns or less). The average internal diameter of the reagent capillary 112 can range from any of the minimum values described above to any of the maximum values described above. For example, the reagent capillary 112 can have an average internal diameter of from 50 microns to 200 microns (e.g., from 50 to 125 microns, from 125 to 200 microns, from 50 to 100 microns, from 100 to 150 microns, from 150 to 200 microns, from 50 to 180 microns, from 50 to 160 microns, from 50 to 140 microns, from 50 to 120 microns, from 50 to 80 microns, from 60 to 200 microns, from 80 to 200 microns, from 100 to 200 microns, from 120 to 200 microns, from 140 to 200 microns, from 160 to 200 microns, from 60 to 190 microns, from 70 to 180 microns, from 80 to 120 microns, or from 90 to 110 microns). In some examples, the reagent capillary 112 has an average internal diameter of 100 microns.

The reagent inlet 114 is configured to receive a fluid reagent. In some examples, the fluid reagent comprises a solvent and a reagent. The solvent can, for example, comprise tetrahydrofuran (THF), N-methyl-2-pyrrolidone (NMP), dimethylformamide (DMF), N-methylformamide, formamide, dichloromethane (CH₂Cl₂), ethylene glycol, polyethylene glycol, glycerol, alkane diol, ethanol, methanol, propanol, isopropanol, water, acetonitrile, chloroform, toluene, methyl acetate, ethyl acetate, acetone, hexane, heptane, tetraglyme, propylene carbonate, diglyme, dimethyl sulfoxide (DMSO), dimethoxyethane, xylene, dimethylacetamide, methylene chloride, hexafluoro-2-propanol, or combinations thereof. In some examples, solvent comprises acetonitrile, water, or a combination thereof.

The reagent can comprise any suitable reagent. In some examples, the reagent is configured to react with the analyte. In some examples, the reagent comprises a derivatization reagent, a hydrolysis reagent, a catalytic reagent, a crosslinking reagent, an adduct forming reagent, or a combination thereof. In some examples, the reagent comprises phenylboronic acid, Girard T reagent, lipase, ammonium cation, chloride anion, or a combination thereof.

In some examples, the reagent has a concentration of greater than 0 mM (e.g., 0.25 mM or more, 0.5 mM or more, 0.75 mM or more, 1 mM or more, 1.25 mM or more, 1.5 mM or more, 2 mM or more, 2.5 mM or more, 3 mM or more, 3.5 mM or more, 4 mM or more, 4.5 mM or more, 5 mM or more, 6 mM or more, 7 mM or more, 8 mM or more, 9 mM or more, 10 mM or more, 15 mM or more, 20 mM or more, 25 mM or more, 30 mM or more, 35 mM or more, 40 mM or more, 45 mM or more, 50 mM or more, 60 mM or more, 70 mM or more, 80 mM or more, or 90 mM or more). In some examples, the reagent has a concentration of 100 mM or less (e.g., 90 mM or less, 80 mM or less, 70 mM or less, 60 mM or less, 50 mM or less, 45 mM or less, 40 mM or less, 35 mM or less, 30 mM or less, 25 mM or less, 20 mM or less, 15 mM or less, 10 mM or less, 9 mM or less, 8 mM or less, 7 mM or less, 6 mM or less, 5 mM or less, 4.5 mM or less, 4 mM or less, 3.5 mM or less, 3 mM or less, 2.5 mM or less, 2 mM or less, 1.5 mM or less, 1.25 mM or less, 1 mM or less, 0.75 mM or less, 0.5 mM or less, or 0.25 mM or less). The concentration of the reagent can range from any of the minimum values described above to any of the maximum values described above. For example, the reagent can have a concentration of from greater than 0 mM to 100 mM (e.g., from greater than 0 mM to 50 mM, from 50 mM to 100 mM, from greater than 0 mM to 20 mM, from 20 mM to 40 mM, from 40 mM to 60 mM, from 60 mM to 80 mM, from 80 mM to 100 mM, from greater than 0 mM to 90 mM, from greater than 0 mM to 80 mM, from greater than 0 mM to 60 mM, from greater than 0 mM to 40 mM, from greater than 0 mM to 15 mM, from greater than 0 mM to 10 mM, from 0.25 mM to 100 mM, from 0.5 mM to 100 mM, from 1 mM to 100 mM, from 5 mM to 100 mM, from 10 mM to 100 mM, from 15 mM to 100 mM, from 20 mM to 100 mM, from 40 mM to 100 mM, from 60 mM to 100 mM, from 0.25 mM to 90 mM, from 1 mM to 80 mM, or from 1 mM to 10 mM). In some examples, the reagent has a concentration of 4 mM.

In some examples, the reagent inlet 114 is fluidly coupled to a reagent source (not shown). In some examples, the electrospray emitter device 100 further comprises a pump (not shown) fluidly connected to the reagent source and the reagent inlet 114, the pump being configured to inject the fluid reagent into the reagent inlet 114.

Referring again to FIG. 1, the electrospray emitter device 100 further comprises a voltage source 120 conductively coupled to the reagent capillary 112 and configured to apply a voltage to the reagent capillary 112. In some examples, the voltage applied to the reagent capillary 112 can be 0 kV or more (e.g., 0.5 kV or more, 1 kV or more, 1.5 kV or more, 2 kV or more, 2.5 kV or more, 3 kV or more, 3.5 kV or more, 4 kV or more, 4.5 kV or more, 5 kV or more, 5.5 kV or more, 6 kV or more, 6.5 kV or more, 7 kV or more, 7.5 kV or more, 8 kV or more, 8.5 kV or more, 9 kV or more, or 9.5 kV or more). In some examples, the voltage applied to the reagent capillary 112 can be 10 kV or less (e.g., 9.5 kV or less, 9 kV or less, 8.5 kV or less, 8 kV or less, 7.5 kV or less, 7 kV or less, 6.5 kV or less, 6 kV or less, 5.5 kV or less, 5 kV or less, 4.5 kV or less, 4 kV or less, 3.5 kV or less, 3 kV or less, 2.5 kV or less, 2 kV or less, 1.5 kV or less, 1 kV or less, or 0.5 kV or less). The voltage applied to the reagent capillary 112 can range from any of the minimum values described above to any of the maximum values described above. For example, the voltage applied to the reagent capillary can be from 0 kV to 10 kV (e.g., from 0 kV to 5 kV, from 5 kV to 10 kV, from 0 kV to 2 kV, from 2 kV to 4 kV, from 4 kV to 6 kV, from 6 kV to 8 kV, from 8 kV to 10 kV, from 1 kV to 10 kV, from 2 kV to 10 kV, from 3 kV to 10 kV, from 4 kV to 10 kV, from 6 kV to 10 kV, from 7 kV to 10 kV, from 0 kV to 9 kV, from 0 kV to 8 kV, from 0 kV to 7 kV, from 0 kV to 6 kV, from 0 kV to 4 kV, from 0 kV to 3 kV, from 1 kV to 9 kV, from 2 kV to 8 kV, or from 5 kV to 8 kV). In some examples, the voltage applied to the reagent capillary 112 is 6.5 kV.

The electrospray emitter device 100 can further comprise a first conduit 130 disposed around a first portion of the sample capillary 102 and a first portion of the reagent capillary 112. The first conduit comprises a wall 132 defining a lumen 133, the lumen 133 defining a path for fluid flow. The first conduit 130 extends from a first end 134 to a second end 136 opposite and axially spaced apart from the first end 134. The sample outlet 106 and the reagent outlet 116 each extend beyond the second end 136 of the first conduit 130 such that the sample outlet 106 and the reagent outlet 116 are each disposed outside of the first conduit 130.

The first conduit 130 can be fabricated from any suitable material or combination of materials compatible with the devices and methods described herein. Examples of suitable materials can include polymers, silicones, glasses, metals, ceramics, inorganic materials, and combinations thereof. In some examples, the first conduit 130 comprises stainless steel.

The first conduit 130 further comprises a carrier gas inlet 138 fluidly connected to the lumen 133, the carrier gas inlet 138 being configured to receive a carrier gas. In some examples, the carrier gas inlet 138 is integrally formed with the first conduit 130.

In some examples, the electrospray emitter device 100 can further comprise a carrier gas source (not shown) fluidly connected to the carrier gas inlet 138.

The carrier gas can comprise any suitable gas. In some examples, the carrier gas is selected from nitrogen, helium, argon, hydrogen, oxygen, air, carbon dioxide, or a combination thereof. In some examples, the carrier gas comprises nitrogen.

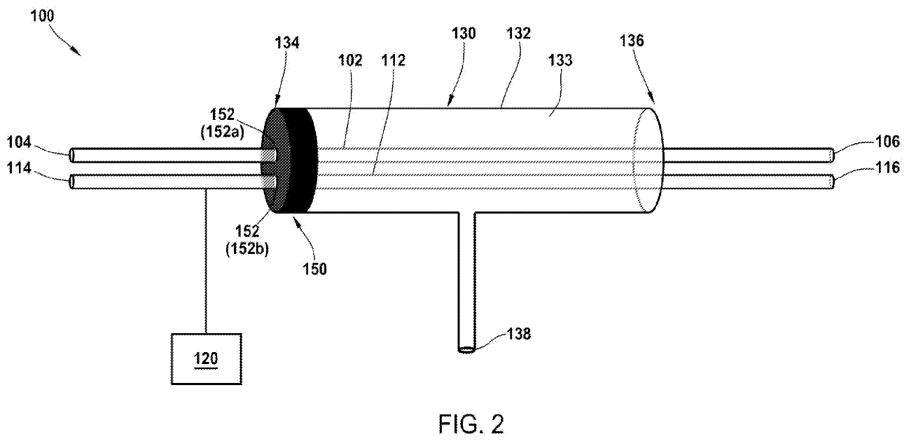

Referring now to FIG. 2, the electrospray emitter device 100 can, in some examples, further comprise a first fitting 150 disposed within the lumen 133 of the first conduit 130 towards the first end 134, the first fitting 150 being coaxial with the first conduit 130. The first fitting 150 can be fluid tight (e.g., can form a fluid tight seal). In some examples, the first fitting 150 can have a one or more ports 152 configured to receive the sample capillary 102 and the reagent capillary 112, such that the sample capillary 102 and the reagent capillary 112 each penetrate through the first fitting 150. In some examples, the first fitting 150 comprises a first port 152a configured to receive the sample capillary 102 and a second port 152b configured to receive the reagent capillary 112.

The first fitting 150 can be fabricated from any suitable material or combination of materials compatible with the devices and methods described herein. Examples of suitable materials can include polymers, silicones, organic materials, inorganic materials, graphite, rubbers, and combinations thereof.

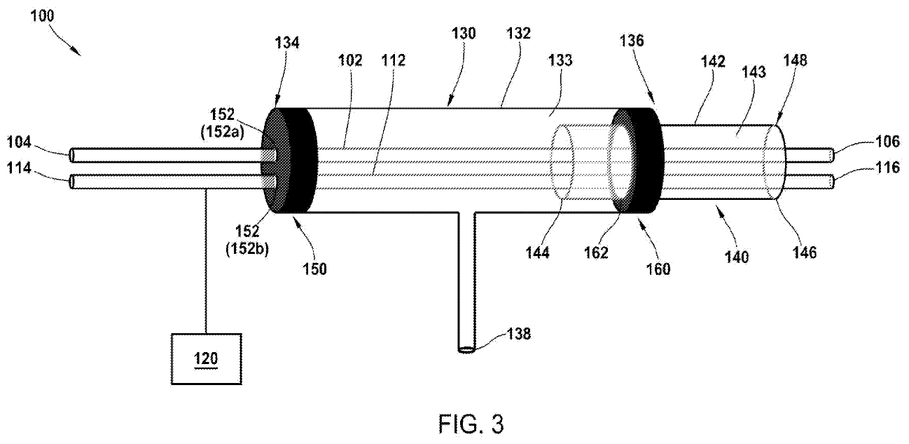

Referring now to FIG. 3, the electrospray emitter device 100 can, in some examples, further comprise a second conduit 140 disposed around a second portion of the sample capillary 102 and a second portion of the reagent capillary 112. The second conduit 140 extends from a proximal end 144 to a distal end 146 opposite and axially spaced apart from the proximal end 144. The second conduit 140 comprises a wall 142 defining a lumen 143, the lumen 143 defining a path for fluid flow terminating in a gas outlet 148 at the distal end 146. The proximal end 144 of the second conduit 140 is disposed within the lumen 133 of the first conduit 130 and the distal end 146 of the second conduit 140 extends beyond the second end 136 of the first conduit 130, such that the first conduit 130 is disposed around a portion of the second conduit 140 and the distal end 146 of the second conduit 140 is disposed outside of the first conduit 130. The sample outlet 106 and the reagent outlet 116 each extend beyond the distal end 146 of the second conduit 140 such that the sample outlet 106 and the reagent outlet 116 are each disposed outside of the second conduit 140.

The second conduit 140 can be fabricated from any suitable material or combination of materials compatible with the devices and methods described herein. Examples of suitable materials can include polymers, silicones, glasses, metals, ceramics, inorganic materials, and combinations thereof. In some examples, the second conduit 140 is formed from a conductive material. Examples of suitable materials can include conductive polymers, conductive silicones, conductive glasses, metals, conductive ceramics, conductive inorganic materials, and combinations thereof. In some examples, the second conduit 140 can be formed from a conductive transparent material. In some examples, the second conduit 140 can be formed from fused silica.

The second conduit 140 can have any suitable dimensions. In some examples, the second conduit 140 has an average internal diameter of 200 microns or more (e.g., 250 microns or more, 300 microns or more, 350 microns or more, 400 microns or more, 450 microns or more, 500 microns or more, 550 microns or more, 600 microns or more, 650 microns or more, 700 microns or more, 750 microns or more, 800 microns or more, 850 microns or more, 900 microns or more, or 950 microns or more). In some examples, the second conduit 140 has an average internal diameter of 1000 microns or less (e.g., 950 microns or less, 900 microns or less, 850 microns or less, 800 microns or less, 750 microns or less, 700 microns or less, 650 microns or less, 600 microns or less, 550 microns or less, 500 microns or less, 450 microns or less, 400 microns or less, 350 microns or less, 300 microns or less, or 250 microns or less). The average internal diameter of the second conduit 140 can range from any of the minimum values described above to any of the maximum values described above. For example, the second conduit 140 can have an average internal diameter of from 200 microns to 1000 microns (e.g., from 200 microns to 600 microns, from 600 microns to 1000 microns, from 200 microns to 400 microns, from 400 microns to 600 microns, from 600 microns to 800 microns, from 800 microns to 1000 microns, from 300 microns to 1000 microns, from 400 microns to 1000 microns, from 500 microns to 1000 microns, from 700 microns to 1000 microns, from 200 microns to 900 microns, from 200 microns to 800 microns, from 200 microns to 700 microns, from 200 microns to 500 microns, from 250 microns to 950 microns, from 300 microns to 900 microns, from 300 microns to 600 microns, or from 400 microns to 500 microns). In some examples, the second conduit 140 has an average internal diameter of 450 microns.

In some examples, the electrospray emitter device 100 further comprises a second fitting 160 disposed within the lumen 133 of the first conduit 130 towards the second end 136, the second fitting 160 being coaxial with the first conduit 130. The second fitting 160 has an orifice 162 configured to receive the second conduit 140 such that the second conduit 140 penetrates through the second fitting 160 and the second fitting 160 is disposed around a portion of the second conduit 140. In some examples, the second fitting 160 forms a fluid tight seal extending between the first conduit 130 and the second conduit 140.

The second fitting 160 can be fabricated from any suitable material or combination of materials compatible with the devices and methods described herein. Examples of suitable materials can include polymers, silicones, organic materials, inorganic materials, graphite, rubbers, and combinations thereof.

Any of the electrospray devices 100 disclosed herein can, in some examples, further comprise a liquid chromatograph fluidly coupled to the sample inlet 104, such that the liquid chromatograph is configured to inject the fluid sample into the sample inlet 104.

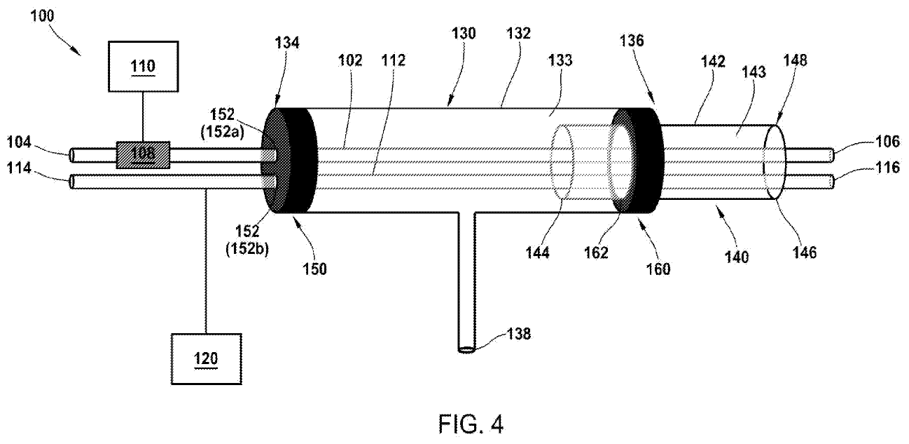

Referring now to FIG. 4, the sample capillary 102 can, in some examples, comprises a section 108 disposed between the sample inlet 104 and the first end 134 of the first conduit 130, and said section 108 being grounded. For example, the section 108 can shield the liquid chromatograph, e.g., from the voltage applied by the voltage source. In some examples, the section 108 is conductively coupled to a ground source 110. The section be fabricated from any suitable material or combination of materials compatible with the devices and methods described herein. Examples of suitable materials can include polymers, silicones, organic materials, inorganic materials, and combinations thereof. In some examples, the section 108 comprises PEEK.

Any of the electrospray devices 100 disclosed herein can, in some examples, further comprise an analyzer positioned to receive an electrosprayed sample from the sample outlet 106 and the reagent outlet 116. In some examples, the analyzer comprises a mass spectrometer. The mass spectrometer can be any suitable mass spectrometer, including a tandem mass spectrometer.

### Methods of Use

Also disclosed herein are methods of use of any of the electrospray emitter devices 100 disclosed herein. For example, the methods can comprise injecting a fluid sample into the sample inlet 104.

The fluid sample can, for example, be an eluent from a liquid chromatograph. In some examples, the fluid sample is injected from a liquid chromatograph.

In some examples, the fluid sample comprises a solvent and an analyte. The solvent can, for example, comprise tetrahydrofuran (THF), N-methyl-2-pyrrolidone (NMP), dimethylformamide (DMF), N-methylformamide, formamide, dichloromethane (CH₂Cl₂), ethylene glycol, polyethylene glycol, glycerol, alkane diol, ethanol, methanol, propanol, isopropanol, water, acetonitrile, chloroform, toluene, methyl acetate, ethyl acetate, acetone, hexane, heptane, tetraglyme, propylene carbonate, diglyme, dimethyl sulfoxide (DMSO), dimethoxyethane, xylene, dimethylacetamide, methylene chloride, hexafluoro-2-propanol, or combinations thereof. In some examples, solvent comprises acetonitrile, water, or a combination thereof.

The fluid sample can comprise any liquid sample of interest. By way of example the fluid sample can comprise a bodily fluid. “Bodily fluid”, as used herein, refers to a fluid composition obtained from or located within a human or animal subject. Bodily fluids include, but are not limited to, urine, whole blood, blood plasma, serum, tears, semen, saliva, sputum, exhaled breath, nasal secretions, pharyngeal exudates, bronchoalveolar lavage, tracheal aspirations, interstitial fluid, lymph fluid, meningeal fluid, amniotic fluid, glandular fluid, feces, perspiration, mucous, vaginal or urethral secretion, cerebrospinal fluid, and transdermal exudate. Bodily fluid also includes experimentally separated fractions of all of the preceding solutions, as well as mixtures containing homogenized solid material, such as feces, tissues, and biopsy samples. In some examples, the fluid sample comprises a bodily fluid, such as urine, plasma, or a combination thereof. In some examples, the bodily fluid comprises a saccharide, a lipid, a fatty acid, a steroid, a protein, a nucleic acid (e.g., DNA, RNA), or a combination thereof. In some examples, the bodily fluid comprises a saccharide. such as a monosaccharide, a disaccharide, an oligosaccharide, or a combination thereof.

The analyte can comprise any analyte of interest. For example, the analyte can comprise a saccharide, a lipid, a fatty acid, a steroid, a protein, a nucleic acid (e.g., DNA, RNA), or a combination thereof. In some examples, the analyte can comprise a saccharide, such as a monosaccharide, a disaccharide, an oligosaccharide, or a combination thereof.

In some examples, the fluid sample can be injected at a flow rate of 1 μL/minute or more (e.g., 2 μL/minute or more, 3 μL/minute or more, 4 μL/minute or more, 5 μL/minute or more, 10 μL/minute or more, 15 μL/minute or more, 20 μL/minute or more, 25 μL/minute or more, 30 μL/minute or more, 35 μL/minute or more, 40 μL/minute or more, 45 μL/minute or more, 50 μL/minute or more, 55 μL/minute or more, 60 μL/minute or more, 65 μL/minute or more, 70 μL/minute or more, 75 μL/minute or more, 80 μL/minute or more, 85 μL/minute or more, 90 μL/minute or more, or 95 μL/minute or more). In some examples the fluid sample can be injected at a flow rate of 100 μL/minute or less (e.g., 95 μL/minute or less, 90 μL/minute or less, 85 μL/minute or less, 80 μL/minute or less, 75 μL/minute or less, 70 μL/minute or less, 65 μL/minute or less, 60 μL/minute or less, 55 μL/minute or less, 50 μL/minute or less, 45 μL/minute or less, 40 μL/minute or less, 35 μL/minute or less, 30 μL/minute or less, 25 μL/minute or less, 20 μL/minute or less, 15 μL/minute or less, 10 μL/minute or less, or 5 μL/minute or less). The flow rate at which the fluid sample is injected can range from any of the minimum values described above to any of the maximum values described above. For example, the fluid sample can be injected at a flow rate of from 1 μL/minute to 100 μL/minute (e.g., from 1 μL/minute to 50 μL/minute, from 50 μL/minute to 100 μL/minute, from 1 μL/minute to 20 μL/minute, from 20 μL/minute to 40 μL/minute, from 40 μL/minute to 60 μL/minute, from 60 μL/minute to 80 μL/minute, from 80 μL/minute to 100 μL/minute, from 1 μL/minute to 80 μL/minute, from 1 μL/minute to 60 μL/minute, from 1 μL/minute to 40 μL/minute, from 5 μL/minute to 100 μL/minute, from 10 μL/minute to 100 μL/minute, from 20 μL/minute to 100 μL/minute, from 40 μL/minute to 100 μL/minute, from 60 μL/minute to 100 μL/minute, from 70 μL/minute to 100 μL/minute, from 5 μL/minute to 95 μL/minute, from 10 μL/minute to 90 μL/minute, from 60 μL/minute to 90 μL/minute, or from 70 μL/minute to 80 μL/minute). In some examples, the fluid sample is injected at a flow rate of 75 μL/minute.

The methods can further comprise injecting a fluid reagent into the reagent inlet 114. In some examples, the fluid reagent is injected from a reagent source. In some examples, the fluid reagent is injected by a pump.

In some examples, the fluid reagent comprises a solvent and a reagent. The solvent can, for example, comprise tetrahydrofuran (THF), N-methyl-2-pyrrolidone (NMP), dimethylformamide (DMF), N-methylformamide, formamide, dichloromethane (CH₂Cl₂), ethylene glycol, polyethylene glycol, glycerol, alkane diol, ethanol, methanol, propanol, isopropanol, water, acetonitrile, chloroform, toluene, methyl acetate, ethyl acetate, acetone, hexane, heptane, tetraglyme, propylene carbonate, diglyme, dimethyl sulfoxide (DMSO), dimethoxyethane, xylene, dimethylacetamide, methylene chloride, hexafluoro-2-propanol, or combinations thereof. In some examples, solvent comprises acetonitrile, water, or a combination thereof.

The reagent can comprise any suitable reagent. In some examples, the reagent is configured to react with the analyte. In some examples, the reagent comprises a derivatization reagent, a hydrolysis reagent, a catalytic reagent, a crosslinking reagent, an adduct forming reagent, or a combination thereof. In some examples, the reagent comprises phenylboronic acid, Girard T reagent, lipase, ammonium cation, chloride anion, or a combination thereof.

In some examples, the reagent has a concentration of greater than 0 mM (e.g., 0.25 mM or more, 0.5 mM or more, 0.75 mM or more, 1 mM or more, 1.25 mM or more, 1.5 mM or more, 2 mM or more, 2.5 mM or more, 3 mM or more, 3.5 mM or more, 4 mM or more, 4.5 mM or more, 5 mM or more, 6 mM or more, 7 mM or more, 8 mM or more, 9 mM or more, 10 mM or more, 15 mM or more, 20 mM or more, 25 mM or more, 30 mM or more, 35 mM or more, 40 mM or more, 45 mM or more, 50 mM or more, 60 mM or more, 70 mM or more, 80 mM or more, or 90 mM or more). In some examples, the reagent has a concentration of 100 mM or less (e.g., 90 mM or less, 80 mM or less, 70 mM or less, 60 mM or less, 50 mM or less, 45 mM or less, 40 mM or less, 35 mM or less, 30 mM or less, 25 mM or less, 20 mM or less, 15 mM or less, 10 mM or less, 9 mM or less, 8 mM or less, 7 mM or less, 6 mM or less, 5 mM or less, 4.5 mM or less, 4 mM or less, 3.5 mM or less, 3 mM or less, 2.5 mM or less, 2 mM or less, 1.5 mM or less, 1.25 mM or less, 1 mM or less, 0.75 mM or less, 0.5 mM or less, or 0.25 mM or less). The concentration of the reagent can range from any of the minimum values described above to any of the maximum values described above. For example, the reagent can have a concentration of from greater than 0 mM to 100 mM (e.g., from greater than 0 mM to 50 mM, from 50 mM to 100 mM, from greater than 0 mM to 20 mM, from 20 mM to 40 mM, from 40 mM to 60 mM, from 60 mM to 80 mM, from 80 mM to 100 mM, from greater than 0 mM to 90 mM, from greater than 0 mM to 80 mM, from greater than 0 mM to 60 mM, from greater than 0 mM to 40 mM, from greater than 0 mM to 15 mM, from greater than 0 mM to 10 mM, from 0.25 mM to 100 mM, from 0.5 mM to 100 mM, from 1 mM to 100 mM, from 5 mM to 100 mM, from 10 mM to 100 mM, from 15 mM to 100 mM, from 20 mM to 100 mM, from 40 mM to 100 mM, from 60 mM to 100 mM, from 0.25 mM to 90 mM, from 1 mM to 80 mM, or from 1 mM to 10 mM). In some examples, the reagent has a concentration of 4 mM.

In some examples, the fluid reagent can be injected at a flow rate of 1 μL/minute or more (e.g., 2 μL/minute or more, 3 μL/minute or more, 4 μL/minute or more, 5 μL/minute or more, 6 μL/minute or more, 7 μL/minute or more, 8 μL/minute or more, 9 μL/minute or more, 10 μL/minute or more, 11 μL/minute or more, 12 μL/minute or more, 13 μL/minute or more, 14 μL/minute or more, 15 μL/minute or more, 16 μL/minute or more, 17 μL/minute or more, 18 μL/minute or more, or 19 μL/minute or more). In some examples, the fluid reagent can be injected at a flow rate of 20 μL/minute or less (e.g., 19 μL/minute or less, 18 μL/minute or less, 17 μL/minute or less, 16 μL/minute or less, 15 μL/minute or less, 14 μL/minute or less, 13 μL/minute or less, 12 μL/minute or less, 11 μL/minute or less, 10 μL/minute or less, 9 μL/minute or less, 8 μL/minute or less, 7 μL/minute or less, 6 μL/minute or less, 5 μL/minute or less, 4 μL/minute or less, 3 μL/minute or less, or 2 μL/minute or less). The flow rate at which the fluid reagent is injected can range from any of the minimum values described above to any of the maximum values described above. For example, the fluid reagent can be injected at a flow rate of from 1 μL/minute to 20 μL/minute (e.g., from 1 μL/minute to 10 μL/minute, from 10 μL/minute to 20 μL/minute, from 1 μL/minute to 5 μL/minute, from 5 μL/minute to 10 μL/minute, from 10 μL/minute to 15 μL/minute, from 15 μL/minute to 20 μL/minute, from 2 μL/minute to 20 μL/minute, from 4 μL/minute to 20 μL/minute, from 6 μL/minute to 20 μL/minute, from 8 μL/minute to 20 μL/minute, from 12 μL/minute to 20 μL/minute, from 14 μL/minute to 20 μL/minute, from 16 μL/minute to 20 μL/minute, from 1 μL/minute to 18 μL/minute, from 1 μL/minute to 16 μL/minute, from 1 μL/minute to 14 μL/minute, from 1 μL/minute to 12 μL/minute, from 1 μL/minute to 8 μL/minute, from 1 μL/minute to 6 μL/minute, from 2 μL/minute to 19 μL/minute, from 3 μL/minute to 18 μL/minute, from 2 μL/minute to 8 μL/minute, or from 4 μL/minute to 6 μL/minute). In some examples, the fluid reagent is injected at a flow rate of 5 μL/minute.

In some examples, the methods can further comprise forming a droplet of the fluid sample at the sample outlet 106 and forming a droplet of the fluid reagent at the reagent outlet 116; and injecting a carrier gas into the carrier gas inlet 138, thereby contacting the droplet of the fluid sample and the droplet of the fluid reagent with the carrier gas. The carrier gas can comprise any suitable gas. In some examples, the carrier gas is selected from nitrogen, helium, argon, hydrogen, oxygen, air, carbon dioxide, or a combination thereof. In some examples, the carrier gas comprises nitrogen.

In some examples, the carrier gas is injected at a pressure of 0 psi or more (e.g., 1 psi or more, 2 psi or more, 3 psi or more, 4 psi or more, 5 psi or more, 10 psi or more, 15 psi or more, psi or more, 25 psi or more, 30 psi or more, 35 psi or more, 40 psi or more, 45 psi or more, 50 psi or more, 60 psi or more, 70 psi or more, 80 psi or more, 90 psi or more, 100 psi or more, 110 psi or more, 120 psi or more, 130 psi or more, or 140 psi or more). In some examples, the carrier gas is injected at a pressure of 150 psi or less (e.g., 140 psi or less, 130 psi or less, 120 psi or less, 110 psi or less, 100 psi or less, 90 psi or less, 80 psi or less, 70 psi or less, 60 psi or less, 50 psi or less, 45 psi or less, 40 psi or less, 35 psi or less, 30 psi or less, 25 psi or less, 20 psi or less, psi or less, 10 psi or less, 5 psi or less, 4 psi or less, 3 psi or less, 2 psi or less, or 1 psi or less). The pressure at which the carrier gas is injected can range from any of the minimum values described above to any of the maximum values described above. For example, the carrier gas can be injected at a pressure of from 0 to 150 psi (e.g., from 0 psi to 75 psi, from 75 psi to 150 psi, from 0 psi to 50 psi, from 50 psi to 100 psi, from 100 psi to 150 psi, from 0 psi to 125 psi, from 0 psi to 100 psi, from 0 psi to 25 psi, from 0 psi to 10 psi, from 0 psi to 5 psi, from 1 psi to 150 psi, from 5 psi to 150 psi, from 10 psi to 150 psi, from 25 psi to 150 psi, from 50 psi to 150 psi, from 1 psi to 140 psi, from 5 psi to 130 psi, from 1 psi to 25 psi, from 1 psi to 10 psi, or from 1 psi to psi).

In some examples, the methods further comprise ejecting the droplet of the fluid sample from the sample outlet 106 and ejecting the droplet of the fluid reagent from the reagent outlet 116. In some examples, ejecting the droplets comprises adjusting a pressure at which the carrier gas is injected, adjusting a flow rate at which the fluid sample is injected, adjusting the flow rate at which the fluid reagent is injected, adjusting the voltage applied to the sample capillary, or a combination thereof.

In some examples, the ejected droplet of the fluid sample comprises an ionized form of the analyte, the ejected droplet of the fluid reagent comprises an ionized form of the reagent, or a combination thereof.

In some examples, the ejected droplet of the fluid sample and the ejected droplet of the fluid reagent form a single Taylor cone.

In some examples, the ejected droplet of the fluid sample contacts and reacts with the ejected droplet of the fluid reagent, thereby forming one or more droplets comprising a reacted sample. In these examples, the voltage applied, the time for which the working gas is contacted with the droplet(s), the carrier gas, the pressure at which the carrier gas is injected, or a combination thereof can be selected to study the reaction occurring in the droplet (e.g., to study the reaction kinetics).

In some examples, the reagent comprises a derivatization reagent and the reacted sample comprises a derivatized form of the analyte.

In some examples, the reaction is achieved on a timescale similar to electrospray microdroplet lifetimes.

In some examples, the reaction is achieved in an amount of time 1 microsecond or more (e.g., 2 microseconds or more, 3 microseconds or more, 4 microseconds or more, 5 microseconds or more, 10 microseconds or more, 15 microseconds or more, 20 microseconds or more, 25 microseconds or more, 30 microseconds or more, 40 microseconds or more, 50 microseconds or more, 75 microseconds or more, 100 microseconds or more, 125 microseconds or more, 150 microseconds or more, 200 microseconds or more, 250 microseconds or more, 300 microseconds or more, 350 microseconds or more, 400 microseconds or more, 450 microseconds or more, 500 microseconds or more, 600 microseconds or more, 700 microseconds or more, 800 microseconds or more, 900 microseconds or more, 1 millisecond or more, 2 milliseconds or more, 3 milliseconds or more, 4 milliseconds or more, 5 milliseconds or more, 10 milliseconds or more, 15 milliseconds or more, 20 milliseconds or more, 25 milliseconds or more, 30 milliseconds or more, 40 milliseconds or more, 50 milliseconds or more, 75 milliseconds or more, 100 milliseconds or more, 125 milliseconds or more, 150 milliseconds or more, 200 milliseconds or more, 250 milliseconds or more, 300 milliseconds or more, 350 milliseconds or more, 400 milliseconds or more, 450 milliseconds or more, 500 milliseconds or more, 600 milliseconds or more, 700 milliseconds or more, 800 milliseconds or more, 900 milliseconds or more, 1 second or more, 2 seconds or more, 3 seconds or more, 4 seconds or more, 5 seconds or more, 10 seconds or more, 15 seconds or more, 20 seconds or more, 25 seconds or more, 30 seconds or more, 35 seconds or more, 40 seconds or more, 45 seconds or more, 50 seconds or more, or 55 seconds or more). In some examples, the reaction is achieved in an amount of time of 1 minute or less (e.g., 55 seconds or less, 50 seconds or less, 45 seconds or less, 40 seconds or less, 35 seconds or less, 30 seconds or less, 25 seconds or less, 20 seconds or less, 15 seconds or less, 10 seconds or less, 5 seconds or less, 4 seconds or less, 3 seconds or less, 2 seconds or less, 1 seconds or less, 900 milliseconds or less, 800 milliseconds or less, 700 milliseconds or less, 600 milliseconds or less, 500 milliseconds or less, 450 milliseconds or less, 400 milliseconds or less, 350 milliseconds or less, 300 milliseconds or less, 250 milliseconds or less, 200 milliseconds or less, 150 milliseconds or less, 125 milliseconds or less, 100 milliseconds or less, 75 milliseconds or less, 50 milliseconds or less, 40 milliseconds or less, 30 milliseconds or less, milliseconds or less, 20 milliseconds or less, 15 milliseconds or less, 10 milliseconds or less, milliseconds or less, 4 milliseconds or less, 3 milliseconds or less, 2 milliseconds or less, 1 millisecond or less, 900 microseconds or less, 800 microseconds or less, 700 microseconds or less, 600 microseconds or less, 500 microseconds or less, 450 microseconds or less, 400 microseconds or less, 350 microseconds or less, 300 microseconds or less, 250 microseconds or less, 200 microseconds or less, 150 microseconds or less, 125 microseconds or less, 100 microseconds or less, 75 microseconds or less, 50 microseconds or less, 40 microseconds or less, microseconds or less, 25 microseconds or less, 20 microseconds or less, 15 microseconds or less, 10 microseconds or less, 5 microseconds or less, 4 microseconds or less, 3 microseconds or less, or 2 microseconds or less). The time in which the reaction is achieved can range from any of the minimum values described above to any of the maximum values described above. For example, the reaction can be achieved in an amount of time of from 1 microsecond to 1 minute (e.g., from 1 microsecond to 1 millisecond, from 1 millisecond to 1 second, from 1 second to 1 minute, from 1 microsecond to 55 seconds, from 5 microseconds to 1 minute, from 5 microseconds to 55 seconds, from 1 microsecond to 45 seconds, from 1 microsecond to 30 seconds, from 1 microsecond to 20 seconds, from 1 microsecond to 10 seconds, from 1 microsecond to 5 seconds, or from 1 microsecond to 1 second).

In some examples, the methods can further comprise collecting one or more of the one or more droplets comprising the reacted sample.

In some examples, the methods can further comprise injecting one or more of the one or more droplets comprising the reacted sample into an analyzer. In some examples, the analyzer comprises a mass spectrometer. The mass spectrometer can be any suitable mass spectrometer, including a tandem mass spectrometer.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Liquid Chromatography-Tandem Mass Spectrometry with Online, In-Source Droplet-Based Phenylboronic Acid Derivatization for Sensitive Analysis of Saccharides

Abstract. The ability to identify abnormalities in the body's saccharide profile is a promising means for early disease detection. Thus, analytical tools capable of detecting saccharides at low concentrations and/or for volume-limited samples are essential. Liquid chromatography-electrospray ionization-mass spectrometry (LC-ESI-MS) is the preferred methodology for these compounds due its inherent specificity. However, saccharides generally exhibit limited sensitivity in electrospray platforms due to the absence of an easily ionized functionality. Herein, a coaxial-flow, contained-electrospray ionization (contained-ESI) source configured within a traditional LC-MS platform is employed for the online and automated separation, derivatization, and detection of various mono-, di-, and oligosaccharides (FIG. 16). For this work, the formation of phenylboronate ester derivatives is achieved in real-time directly in the charged microdroplet environment based on the reaction of phenylboronic acid with vicinal-diol moieties on the sugars. The LC-contained-ESI-MS/MS method allows for the chromatographic differentiation of isobaric saccharides and is highly sensitive, exhibiting femtomole limits of detection for a one microliter injection. Compared with conventional LC-ESI-MS/MS, in-source droplet-based phenylboronic acid derivatization yields sensitivity enhancements of one to two orders of magnitude for most sugars, while offering acceptable accuracy and precision and a linear range of at least two orders of magnitude. The method is demonstrated for the targeted analysis of select oligosaccharides in complex physiological samples, including human urine and plasma.

Introduction. Despite the abundance of advanced instrumentation available today, there is still no single, universal technique that can be applied to all analytical problems. Ultimately, the characteristics of the sample and physicochemical properties of the analyte of interest must be reconciled with the limitations of the chosen analytical finish. In some cases, this requires deliberate, chemical modification of the analyte to form analytically discernable analogs. Chemical derivatization of small molecules is a commonly used approach for improving detectability and sensitivity. Historically, this has been accomplished by augmenting the compound of interest with a chromophore or fluorophore for eventual spectroscopic or colorimetric analysis, or by altering its polarity to permit gas chromatographic separation. More recently, derivatization has gained popularity for liquid chromatography (LC)-mass spectrometry (MS) applications, for example using charge augmentation or charge reversal to enhance ion formation, or structural modification to improve selectivity in separations (Higashi T et al. J. Steroid. Biochem. Mol. Biol. 2016, 162, 57-69; Zhao S et al. Trends Analyt. Chem. 2020, 131, 115988; Huang T et al. Anal. Chem. 2019, 91(1), 109-125).

Many traditional bulk-phase derivatization procedures are resource-intensive, multi-step processes that increase analysis cost and decrease throughput. For chromatographic applications, online, post-column derivatization systems offer a significant reduction in resource utilization by carrying out the desired chemical reaction on a smaller scale with minimal intervention from the analyst. However, current post-column derivatization options typically rely on relatively long reaction coils and/or elevated temperatures to facilitate the desired reaction, which can promote band broadening, cause thermal degradation, and lead to reduced sensitivity via dilution (Jones A et al. J Vis. Exp. 2016, 110, 53462).

In previous work, the rate acceleration afforded by electrospray microdroplets was leveraged to carry out real-time chemical derivatization of saccharides directly within the ion source of a mass spectrometer during the ionization process (Heiss D R et al. Anal. Chem. 2021, 93(50), 16779-16786). This was accomplished using a previously developed unique, coaxial flow contained-electrospray ion source (contained-ESI) (Kulyk D S et al. Anal. Chem. 2015, 87(21), 10988-10994). Saccharides typically exhibit poor sensitivity in conventional ESI-MS applications due to the absence of an easily ionizable functional group (Kailemia M J et al. Anal. Chem. 2014, 86(1), 196-212). It was found that in-source, droplet-based derivatization with phenylboronic acid generated much more abundant precursor and product ions in comparison with the underivatized saccharides, resulting in sensitivity enhancement of up to two orders of magnitude. This is possible due to the reaction rate acceleration afforded by desolvating electrospray microdroplets. Confined droplets and thin films are now known to be dynamic reaction vessels able to carry out reactions at much faster rates than bulk systems. Rate acceleration is the result of many factors, including the large surface area-to-volume ratio and significant increases in reagent concentration and surface charge density during microdroplet desolvation.

The contained-ESI source is an augmented electrospray device that allows the introduction of liquid and vapor phase reagents directly into the ion source to facilitate analyte modification during the ionization process. The sample, for the current application analytes eluting from an LC column, and reagent are introduced into the contained-ESI source coaxially via separate capillaries that converge at the tip of the emitter. Reaction occurs within the Taylor cone and ensuing microdroplets concomitant with ion generation. Thus, reactions are achieved on the timescale of electrospray microdroplet lifetimes, that is to say microseconds or seconds (Miller C F et al. Analyst 2017, 142(12), 2152-2160; Venter A et al. Anal. Chem. 2006, 78, 8549-8555). To date, the contained-ESI source has been used to accelerate the enzymatic hydrolysis of lipids, study protein folding, and modify source conditions to mitigate matrix suppression (Kulyk D S et al. Anal. Chem. 2015, 87(21), 10988-10994; Burris B J et al. Anal. Chem. 2021, 93(38), 13001-13007; Miller C F et al. Analyst 2017, 142(12), 2152-2160).

For this work, the coaxial contained-ESI source was configured within a traditional LC-MS platform to facilitate the automated chromatographic separation, in-source microdroplet derivatization, and mass spectrometric detection of a set of seven mono-, di-, and oligosaccharides. Method development and optimization were performed, and the sensitivity gains afforded by in-source droplet-based phenylboronic acid derivatization were quantified. Figures of merit including accuracy, precision, carryover, and linearity were also determined. Finally, the LC-contained-ESI-MS/MS method was demonstrated for the highly sensitive analysis of select oligosaccharides in human plasma and urine.

### EXPERIMENTAL

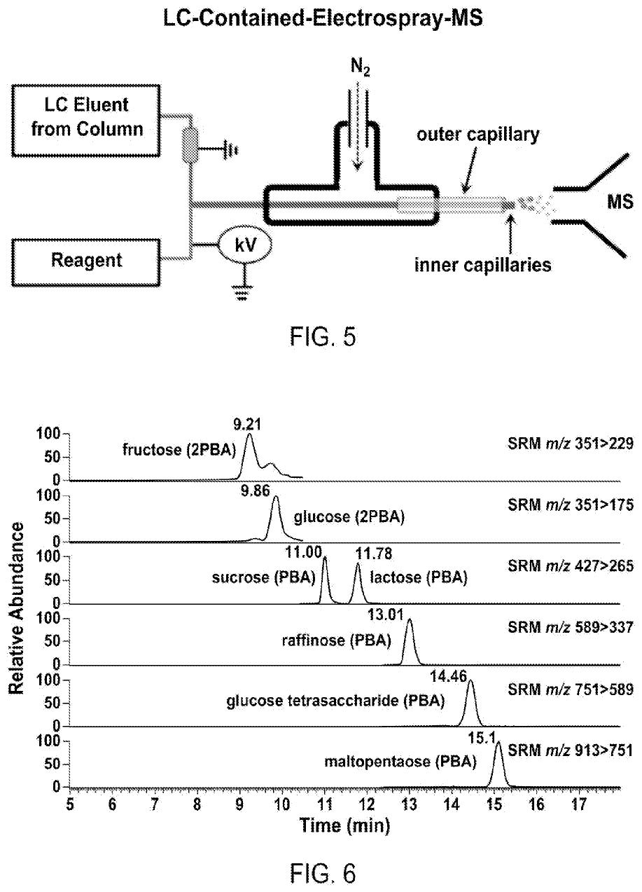

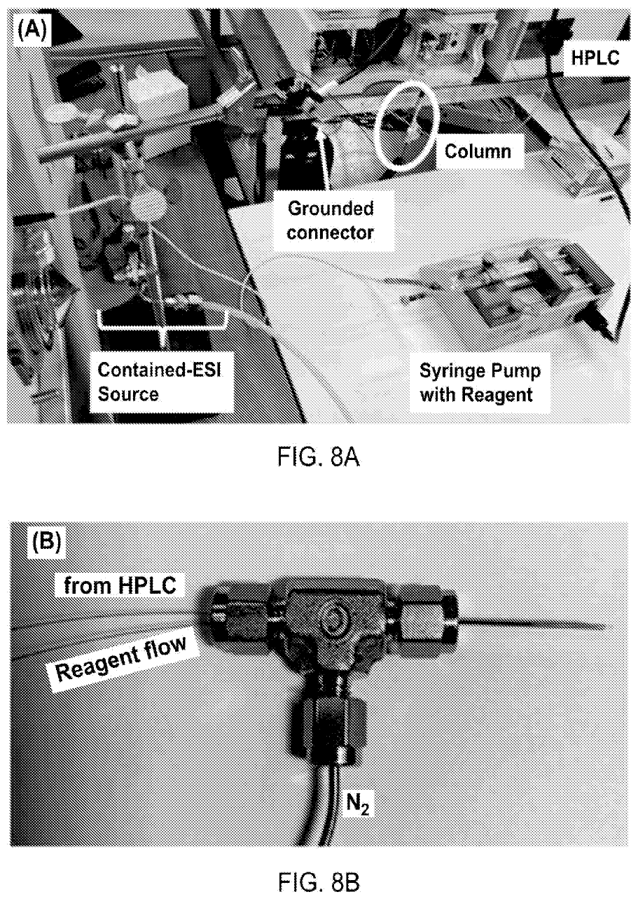

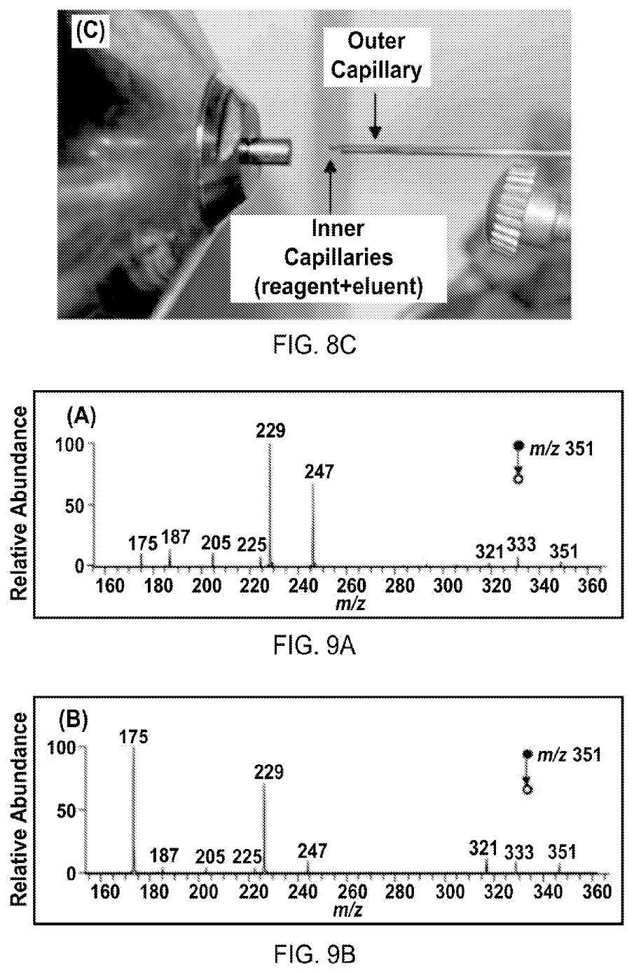

Contained-Electrospray Ion Source. A schematic of the coaxial contained-electrospray ion source configured for LC-MS analysis is shown in FIG. 5. Images of the ion source in operation are included in FIG. 8A-FIG. 8C. The main body is constructed using a stainless-steel Tee with compression fittings (Swagelok®, Solon, OH). The LC eluent and derivatization reagent are delivered to the ion source coaxially via separate fused silica capillaries of 100 μm internal diameter each (190 μm outer diameter). The length of the capillary containing the eluent is minimized to mitigate post-column band broadening. In the configuration employed for this work, the two inner capillaries extend beyond a second, larger (outer) fused silica capillary of 450 μm internal diameter. The reagent solution is delivered using a polypropylene syringe and syringe pump. The analytes eluting from the column mix with the derivatization reagent at the tips of the inner capillaries, creating a single Taylor cone. The desired reaction takes place within the Taylor cone and subsequent electrospray microdroplets during transit to the mass spectrometer inlet.

High voltage from the mass spectrometer is applied to the stainless-steel needle attached to the syringe delivering the reagent via alligator clip. The HPLC eluent (post-column) passes through a short (˜30 cm) piece of black PEEK tubing ( 1/16″ OD, 0.004″ ID) which is connected to a grounded stainless-steel coupler to shield the HPLC electronics from the high electric field of the ion source.

Nitrogen sheath gas is delivered to the ion source via polypropylene tubing and exits through the outer capillary concentric to the two inner capillaries. The sheath gas aids in desolvation and spray stabilization and can be used to adjust reaction time by increasing or decreasing microdroplet lifetime (Miller C F et al. Analyst 2017, 142(12), 2152-2160). Higher sheath gas flow rates provide efficient desolvation and spray stabilization but reduce mixing and reaction time, while lower flow rates increase reaction time but may reduce desolvation effects and destabilize the spray.

Chemicals and Reagents. D-(+)-Glucose (99.5%), fructose (99%), sucrose (99.5%), U-lactose monohydrate (99%), D-(+)-raffinose pentahydrate (99%), and D-glucose-¹³C₆ (99%) were purchased from Sigma-Aldrich (St. Louis, MO). Acetonitrile (ACN) (HPLC grade) and ammonium hydroxide (35% solution in water) were purchased from Fisher Scientific (Pittsburgh, PA). Glucose tetrasaccharide, a.k.a. D-glucopyranosyl maltotriose or Gluc₄ (97%) and maltopentaose (99.9%) were obtained from Biosynth-Carbosynth (Itasca, IL), while phenylboronic acid (>97%) was obtained from Strem Chemicals (Newburyport, MA). High purity deionized water with 18.2 MΩ cm resistivity was prepared using a Milli-Q filtration system (Merck Millipore, Burlington, MA). High-purity nitrogen was used as the sheath gas.

Human urine (pooled, mixed gender) and human plasma (pooled, mixed gender, with K₂EDTA) were obtained from BioIVT (Westbury, NY).

Liquid Chromatography-Contained-Electrospray-Tandem Mass Spectrometry (LC-contained-ESI-MS/MS) Analysis. Final LC-contained-ESI-MS/MS method parameters are included in Table 1A-Table 1D. Chromatographic separation was achieved using an Agilent 1100 HPLC (Agilent Technologies, Santa Clara, CA) fitted with a Waters XBridge BEH Amide column of 50 mm length, 1 mm diameter, and 3 μm particle size (Waters Corp., Milford, MA). Mobile phase A was 90:10 (v:v) acetonitrile:water while mobile phase B was 30:70 (v:v) acetonitrile:water. Both mobile phases also included 0.1% (v:v) ammonium hydroxide as a pH modifier. Separation was carried out using a binary gradient according to the following program: 0.00-10.00 min, 7% B-60% B ramp, 10.00-12.00 min, 60% B hold, 12.01-25.00 min, 7% B hold. Flow rate during the run was set at 0.075 mL/min except for a 5-minute step (17.01-22.00 min) in which the flow rate increased to 0.3 mL/min at initial mobile phase composition to accelerate system re-equilibration. Due to the gradient delay caused by the low flow rate, an injection delay of 6.3 minutes was programmed into the injection cycle. A 1 μL injection volume was used for all analyses.

TABLE 1A
Final LC-contained-ESI-MS/MS system and method parameters
for the analysis of the seven test sugars using in-
source phenylboronic acid derivatization.

| | |
|---|---|
| HPLC | Agilent 1100 |
| Mass Spectrometer | Thermo Finnegan LTQ linear ion trap |
| Software | Thermo Fisher Scientific Xcalibur 2.2 SP1 |
| HPLC Column | Waters XBridge Amide, 50 mm × 1 mm, 3.5 |
| | μm |
| Column Temperature | Ambient |
| Mobile Phases | Mobile Phase A = 90:10 acetonitrile water |
| | (v:v), 0.1% NH₄OH |
| | Mobile Phase B = 30:70 acetonitrile water |
| | (v:v), 0.1% NH₄OH |
| HPLC Gradient | Table 1B |
| Injection Volume | 1 μL |
| Injection Delay | 6.3 minutes |
| Sample composition | 80:20 acetonitrile:aqueous |
| Ion Source Parameters | Table 1C |
| Mass Spectrometer Settings | Table 1D |
| Run Time per Injection | Approximately 25 minutes |

TABLE 1B
Final LC-contained-ESI-MS/MS system and method parameters
for the analysis of the seven test sugars using in-source
phenylboronic acid derivatization - HPLC Gradient (all
changes are linear with respect to time).

| Time | | Flow Rate |
|---|---|---|
| (min) | % B | (mL/min) |
| 0 | 7 | 0.075 |
| 10 | 60 | 0.075 |
| 12 | 60 | 0.075 |
| 12.01 | 7 | 0.075 |
| 17 | 7 | 0.075 |
| 17.01 | 7 | 0.3 |
| 22 | 7 | 0.3 |
| 22.01 | 7 | 0.075 |
| 25 | 7 | 0.075 |

TABLE 1C
Final LC-contained-ESI-MS/MS system and method parameters
for the analysis of the seven test sugars using in-source
phenylboronic acid derivatization - Ion Source Parameters.

| Parameter | Setting |
|---|---|
| Source | Contained-Electrospray (Type I mode) |
| Mode | Negative ion (ESI−) |
| Reagent | 4 mM phenyboronic acid in 1:1 CAN, pH 10 with |
| | NH₄OH |
| Reagent Flow | 5 μL/min |
| Sheath Gas | Nitrogen, 0-5 psi |
| Source Voltage | −6.5 kV |

TABLE 1D
Final LC-contained-ESI-MS/MS system and method parameters for
the analysis of the seven test sugars using in-source phenylboronic
acid derivatization - Mass Spectrometer settings.

| | SRM Transition for | |
|---|---|---|
| Analyte | Derivatized Analyte | CE (%) |
| Fructose | m/z 351 → 175 | 26 |
| Glucose | m/z 351 → 229 | 28 |
| Sucrose | m/z 427 → 265 | 25 |
| Lactose | m/z 427 → 265 | 25 |
| Raffinose | m/z 589 → 337 | 26 |
| Glucose tetrasaccharide | m/z 751 → 589 | 25 |
| Maltopentaose | m/z 913 → 751 | 28 |
| Glucose-¹³C₆ (IS) | m/z 357 → 235 | 25 |

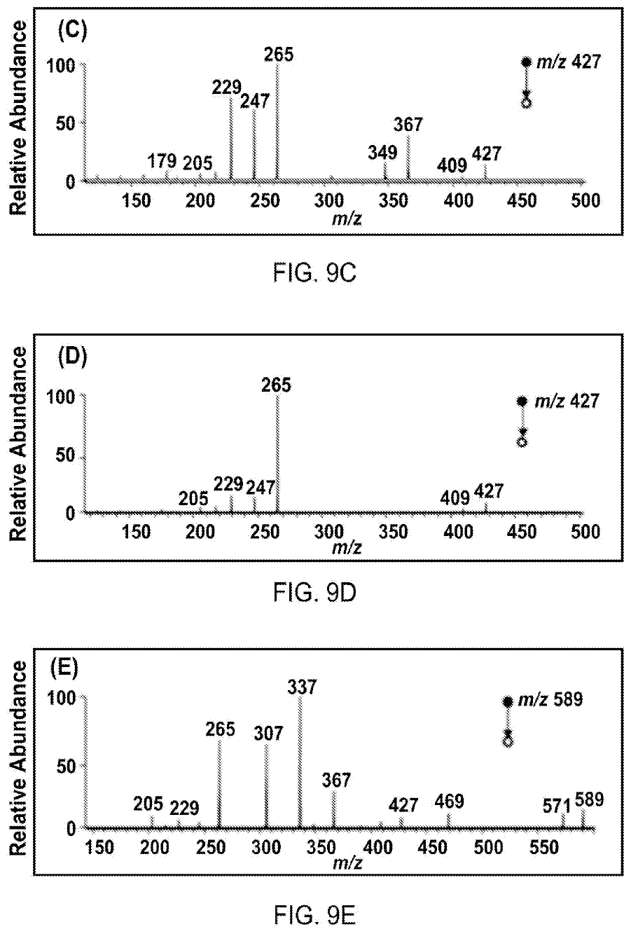

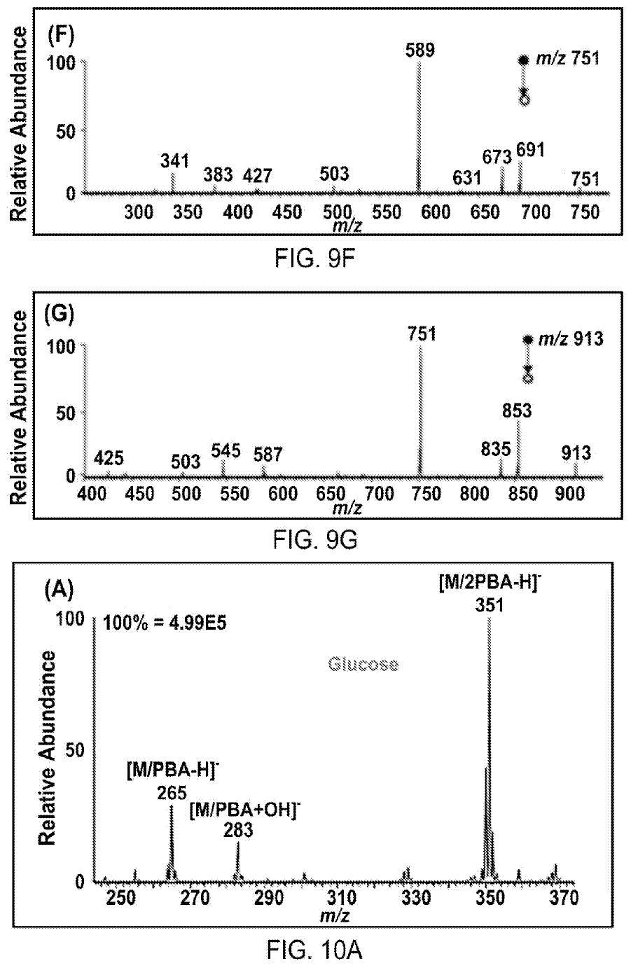

Mass spectrometry analysis was conducted using a Thermo Finnegan LTQ linear ion trap mass spectrometer (Thermo Scientific, San Jose, CA) operating in negative-ion mode. Mass spectrometer inlet temperature, sheath gas pressure, and source voltage were optimized previously (Heiss D R et al. Anal. Chem. 2021, 93(50), 16779-16786). The final source conditions were as follows: sheath gas pressure (N₂)=0-5 psi, source voltage=−6.5 kV, capillary temperature=325° C., reagent concentration=4 mM, reagent flow rate=5 μL/min, and LC eluent flow rate=75 μL/min. Tandem mass spectrometry was performed using collision-induced dissociation (CID). CID settings were established by infusing 10 μM solutions of each individual sugar into the contained-ESI source coaxially with the reagent. The most abundant product ion was identified (see FIG. 9A-FIG. 9G), and the collision energy was optimized to maximize response. SRM transitions selected for analysis are included in Table 1A-Table ID. Data were acquired and processed using Thermo Fisher Scientific Xcalibur 2.2 SP1 software.

Analysis of the underivatized sugars for LOD comparison was carried out using the same HPLC conditions but utilized the commercial Thermo Heated Electrospray Ionization (HESI) source instead of the contained-ESI source. Analysis was performed in negative-ion mode using conventional electrospray conditions with a source voltage of −5 kV, sheath gas setting of 8.0, sweep gas setting of 4.0, auxiliary gas setting of 5.0, and inlet capillary temperature of 220° C.

### Determination of Limits of Detection (LODs) and Limits of Quantification (LOQs).

Range finding analyses were conducted using solvent standards to estimate the concentration yielding a signal-to-noise (S/N) ratio of approximately 5:1 for each derivatized analyte. A mixed standard containing all seven sugars was then prepared at the estimated concentrations and analyzed six times on two separate days (n=12) using the LC-contained-ESI-MS/MS method with in-source droplet-based phenylboronic acid derivatization. Concentrations representing S/N ratios of 3:1 (for LOD) and 10:1 (for LOQ) were calculated for each sugar in each of the replicates. Formal LODs and LOQs were then computed using the average calculated concentration and standard deviation for the twelve replicates along with the appropriate one-sided t-value (99% confidence for LOD, 95% confidence for LOQ) according to Equation 1 and Equation 2 below.

$$LOD = Ave . Conc {.}_{3 : 1} + {t}_{0.01 , 1 , n - 1} ( Std . Dev . ) \qquad ( Equation 1 )$$

$$LOD = Ave . Conc {.}_{10 : 1} + {t}_{0.05 , 1 , n - 1} ( Std . Dev . ) \qquad ( Equation 2 )$$

LODs for the native, underivatized analytes were determined in similar fashion except using the commercial HESI ion source. Previous work revealed that monitoring the deprotonated molecular ion [M−H]⁻ in selected ion monitoring (SIM) mode was more sensitive for most of the underivatized sugars than using MS/MS (Heiss D R et al. Anal. Chem. 2021, 93(50), 16779-16786). Thus, for all underivatized sugars except sucrose and raffinose, SIM mode was used to determine LOD/LOQ. For sucrose, the Selected Reaction Monitoring (SRM) ion transition m/z 341→179 was used while for raffinose, the SRM transition m/z 503→179 was used.

Preparation and Analysis of Calibration Curves. Calibration curves for the phenylboronic acid-derivatized sugars were prepared as follows: individual stock standards for each sugar were prepared in water and used to formulate a mixture containing all seven analytes in 80:20 acetonitrile/water. A series of calibration standards were then prepared by sequentially diluting the mixed standard in 80:20 acetonitrile/water to the desired concentrations (1×, 2×, 5×, 10×, 25×, 50×, and 100×LOQ). Each standard was fortified with the internal standard glucose-¹³C₆ at a concentration of 370 nM (representing 10×LOQ for glucose). The derivatization solution included 4 mM phenylboronic acid in 1:1 acetonitrile/water with pH adjusted to approximately 10 using ammonium hydroxide. Analysis was performed in negative-ion mode using the optimized method parameters and SRM ion transitions shown in Table 1A-Table ID. Peak areas for the two monosaccharides, glucose and fructose, were normalized using the response of the internal standard, while absolute peak areas were used for all other sugars. A least squares linear regression was applied for all analytes, and weighting (1/x or 1/x2) was used in some cases to improve the fit of the model.

Assessment of Accuracy and Precision. The inter-day accuracy and precision of the LC-contained-ESI-MS/MS method were determined at both low (2×LOQ) and high (50×LOQ) concentrations. Six standards at each of the two concentrations were prepared analogously to the calibration standards and analyzed along with a preceding calibration curve. Accuracy was determined by calculating the analyte concentrations using the calibration curves and then determining the average percent deviations of the six standards at each concentration. Precision was represented by the average percent relative standard deviation of the calculated concentrations for the six standards at each of the two concentrations. Intra-day precision was evaluated using a total of thirteen standards prepared at a 10×LOQ concentration and analyzed over the course of two separate days.

Preparation and Analysis of Human Urine and Plasma Samples. Approximately 0.5 mL of each control matrix was transferred to a Microsep™ Advance 3k MW cutoff Centrifugal Filter (Pall Corp., Ann Arbor, MI) and centrifuged at −3000 rpm for 60 minutes to remove high molecular weight compounds. Duplicate 20 μL aliquots of the filtrate were diluted with 80 μL of acetonitrile and vortexed to mix. One of the vials was fortified with 2 μL of a 500×LOQ mix containing raffinose, glucose tetrasaccharide (Gluc4), and maltopentaose to achieve a final concentration of 10×LOQ for analysis. The second vial was spiked with an identical volume of clean 80:20 acetontrile:water to serve as the “blank” control matrix. Analysis of the spiked and blank samples was performed using the method parameters shown in Table 1A-Table ID.

RESULTS AND DISCUSSION. In previous work, direct infusion experiments demonstrated significant gains in sensitivity for saccharides using in-source droplet-based phenylboronic acid derivatization (Scheme 1), a familiar approach to diol functionalization that has proven effective for many classes of compounds including steroids, sugars, and carbohydrates. This reaction was selected from other potential derivatization options due to the aqueous stability of the reagent (a prerequisite when coupling with HPLC) and its ability to react under relatively mild conditions. Unlike some other derivatization options, such as Schiff base formation, the selected reaction does not discriminate between reducing and non-reducing sugars, and thus can be applied to the analysis of a wide range of saccharides.

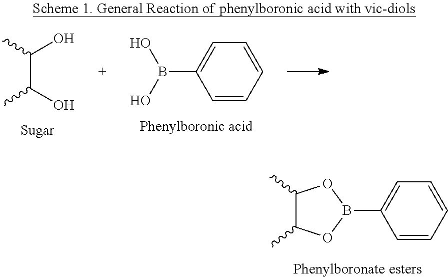

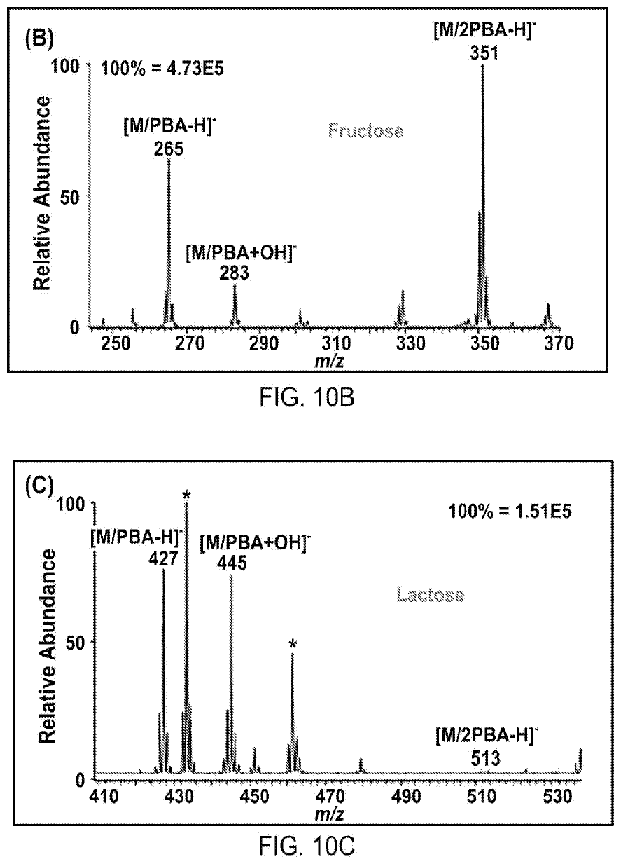

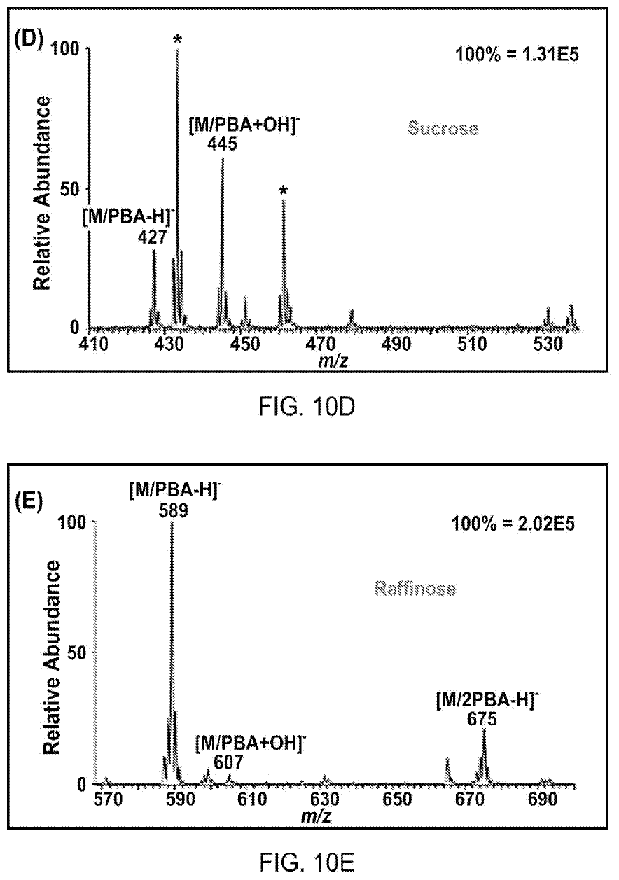

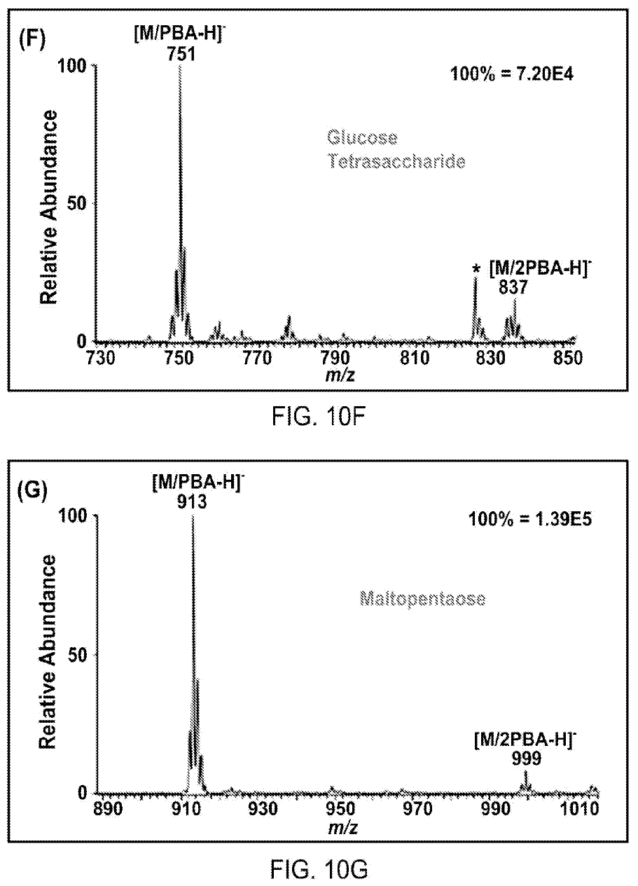

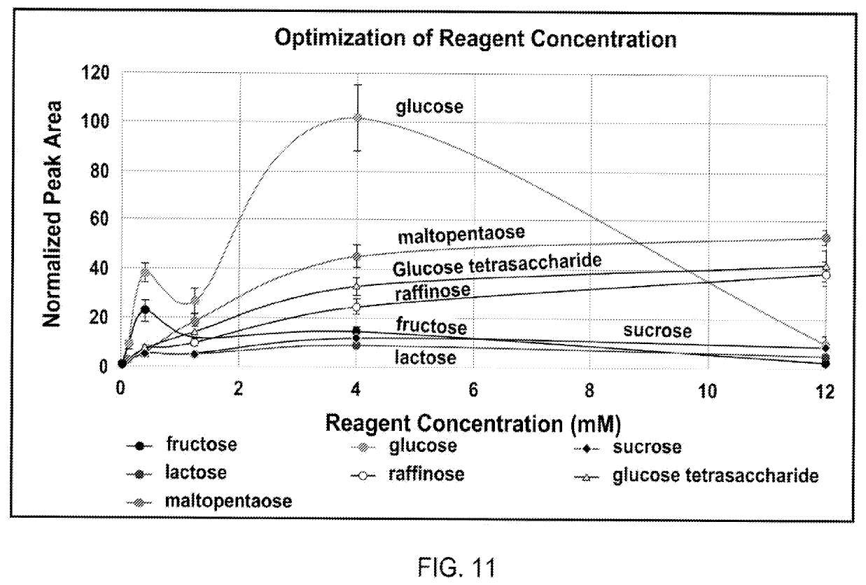

For most of the sugars tested, in-source PBA derivatization resulted in the formation of both the monosubstituted (M/PBA) and disubstituted (M/2PBA) phenylboronate esters (FIG. 10A-FIG. 10G). In the case of the monosaccharides glucose and fructose (MW=180 Da), the bis(phenylboronate) derivatives observed at m/z 351 were more abundant than the monosubstituted versions (m/z 265 and m/z 283). This preference to form the doubly substituted analog stems from conformation changes that occur upon binding of the first boronate group at the C1/C2 position, which encourages the binding of a second boronate group (Peters JA. Coordin. Chem Rev. 2014, 268, 1-22). In contrast, the disaccharides and oligosaccharides [sucrose/lactose (MW=342 Da), raffinose (MW=504 Da), glucose tetrasaccharide (MW=666 Da), and maltopentaose (MW=828 Da)] produced the monosubstituted species most preferably, observed at m/z 427, m/z 589, m/z 751, and m/z 913.

The hydroxylated ions of the monosubstituted analytes (M/PBA+OH) were also apparent in the mass spectra for all of the sugars. Due to its Lewis acidity, boron is known to readily sequester a hydroxide ion in solution to form the hydroxylated precursor ion (Peters JA. Coordin. Chem Rev. 2014, 268, 1-22). For sucrose, the hydroxylated species (m/z 445) was actually more abundant than the deprotonated PBA derivative (m/z 427). Fragmentation of the hydroxylated ions generated primarily the deprotonated product ion after loss of water and did not offer structurally unique product ions; thus, the hydroxylated species were not used for analysis.

Coupling Contained-ESI to LC-MS and Method Development. In many ways, the contained-ESI source operates very similar to traditional electrospray ion sources. Thus, coupling it to a commercial LC-MS platform required only a few alterations. One important addition was the installation of a grounded stainless-steel connector positioned between the HPLC and the contained-ESI source (see FIG. 5). The presence of a grounding point within the sample stream shields the electronics of the HPLC system from the high voltages applied to the ion source.

Another aspect to consider is the compatibility of the source with traditional HPLC flow rates. Typical flow rates employing standard bore columns are usually on the order of 500-2000 μL/min. However, previous testing of the contained-ESI source involved direct infusion experiments at flow rates generally in the range of 5-20 μL/min. To account for this disparity, a microbore HPLC column was utilized, which can accommodate flow rates as low as 50 μL/min due to the smaller column diameter (1 mm). Preliminary experiments performed using increasing flow rates demonstrated that the signal for the derivatized sugars remained mostly unchanged up to about 75 μL/min, beyond which responses began to decrease rather abruptly. One explanation for this effect may be that at lower flow rates, smaller initial droplets with higher surface area-to-volume ratios are generated, resulting in better reaction kinetics. To maximize the sensitivity gains of in-source derivatization while minimizing run time, the chromatographic separation was carried out at a flow rate of 75 μL/min.

Unfortunately, this atypically low flow rate combined with the relatively large volume of the HPLC pre-column components (e.g., mixer, valve, sample loop, tubing, etc.) led to a significant gradient delay. Hardware modifications can be used to reduce system dwell volume, including replacing the mixer with a much smaller dead volume pre-column filter and reducing tubing length and diameter. Rather than replumbing the HPLC and exchanging parts, it was decided to simply program an injection delay into the injection cycle to account for the added time required for the gradient to reach the column. The gradient delay was estimated using a relatively common technique for determining system dwell volume, which utilizes an acetone-fortified mobile phase and diode-array detection (DAD) to establish the actual gradient onset in relation to the programmed gradient (Hong P et al. Waters Corp. White Paper https://www.waters.com/webassets/cms/library/docs/720005723en.pdf. Accessed Feb. 24, 2022). Based on the calculated dwell volume of the system, an appropriate injection delay was defined. For this HPLC system and flow rate, it was found that a delay of 6.3 minutes was appropriate.

The relatively polar nature of saccharides precludes the use of standard reversed-phase conditions, and mobile phases employed for normal-phase separations are generally not compatible with electrospray ionization. HILIC separations, which combine a polar stationary phase with aqueous-containing mobile phases, are ideal for ESI-MS analysis of saccharides. Amide and zwitterionic stationary phases have previously been shown to provide excellent separation of these compounds under HILIC conditions. Amino stationary phases have also been used but were avoided here due to the potential for the bonded phase to react with reducing sugars to form Schiff bases within the column. For this work, a HILIC separation using an amide stationary phase and mobile phases comprising acetonitrile and water were employed. Methanol was avoided due to its potential reactivity toward both the arylboronic acid reagent and the open-chain tautomers of reducing saccharides. Ammonium hydroxide was added to the mobile phases to aid ionization, mitigate peak splitting caused by anomeric mutarotation, and produce optimal pH conditions for the derivatization reaction.

Using these conditions, an excellent separation of M1 to M5 sugars (i.e., monosaccharides to pentasaccharides) was achieved, offering good retention (k=2.8-12) and sufficient resolution for the critical pair of monomeric isomers fructose and glucose (Rₛ=1.46). See FIG. 6. Chromatographic metrics are summarized in Table 2. The method also offered baseline resolution of the isobaric disaccharides sucrose and lactose.

TABLE 2
Chromatographic characteristics for the LC separation
of mono-, di-, and oligosaccharides using the method
described in Table 1A-Table 1D, including retention time (tᵣ),
retention factor (k), and resolution (Rₛ).

| Analyte | # monomers | # carbons | tᵣ (min) | k | Rₛ |
|---|---|---|---|---|---|
| Fructose | 1 | C₆ | 9.2 | 2.8 | 1.46 |
| Glucose | 1 | C₆ | 9.9 | 3.8 | |
| Sucrose | 2 | C₁₂ | 11.0 | 5.6 | — |
| Lactose | 2 | C₁₂ | 11.8 | 6.8 | — |
| Raffinose | 3 | C₁₈ | 13.0 | 8.7 | — |
| Glucose | 4 | C₂₄ | 14.5 | 11 | — |
| tetrasaccharide | | | | | |
| Maltopentaose | 5 | C₃₀ | 15.1 | 12 | — |

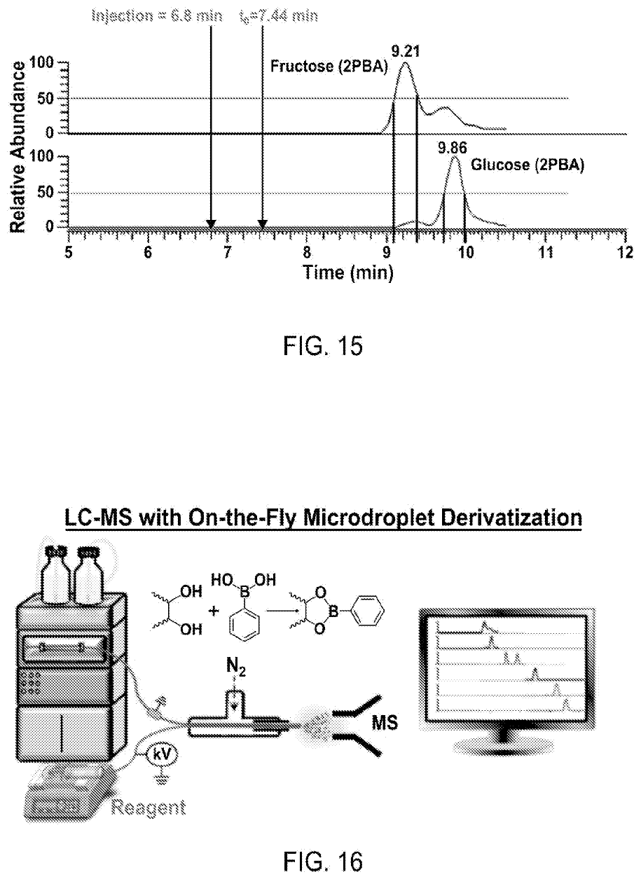

In Table 2, retention factor (k), and resolution (Rₛ) were calculated using the following equations, with an example calculation shown for Fructose and Glucose based on the data shown in FIG. 15.

$${k}_{fructose} = \frac{adjusted {t}_{r} - adjusted {t}_{o}}{adjusted {t}_{o}} = \frac{( 9.21 min - 6.8 min ) - ( 7.44 min - 6.8 min )}{( 7.44 min - 6.8 min )} 2.8$$

$${R}_{s} = \frac{1.18 ( {t}_{2} - {t}_{1} )}{\text{?}} = \frac{1.18 ( 9.86 min - 9.21 min )}{0.275 min + 0.25 min} = 1.46$$

$$\text{?} \text{indicates text missing or illegible when filed}$$

Although most of the contained-ESI source parameters and derivatization conditions were optimized in previous work, additional experiments were necessary to optimize the reagent concentration and flow rate to account for the higher sample flow rate delivered by the HPLC. The optimal reagent concentration was found to be 4 mM (FIG. 10A-FIG. 10G). Negligible increases in response were observed for the three oligosaccharides (raffinose, glucose tetrasaccharide, maltopentaose) using higher concentrations, but the gains were offset by significant decreases in response for the mono- and disaccharides.

The optimal flow rate for the reagent solution was found to be 5 μL/min (FIG. 11). Responses for nearly all of the sugars tested decreased at higher flow rates due to increased solvent molecules and the formation of larger initial droplets. Incomplete mixing may also occur as more of the reagent solution is delivered.

The mass spectrometry method was established by determining appropriate SRM transitions for each of the sugar-PBA derivatives and optimizing collision energies via direct infusion experiments. As discussed above, in-source droplet-based phenylboronic acid derivatization of monosaccharides generates the bis(phenylboronate) esters (2PBA) in greatest abundance, while for disaccharides and oligosaccharides, the monosubstituted derivative (PBA) is preferably formed. Thus, CID was performed on the deprotonated precursor ions associated with either the disubstituted monosaccharides (glucose/fructose—m/z 351) or the monosubstituted di- and oligo-saccharides (sucrose/lactose—m/z 427, raffinose—m/z 589, glucose tetrasaccharide—m/z 751, maltopentaose—m/z 913) to identify the most abundant ion transitions for each sugar (see FIG. 9A-FIG. 9G).

The final, optimized LC-contained-ESI-MS/MS method parameters are included in Table 1A-Table 1D. Representative chromatograms for the seven test sugars are shown in FIG. 6.

Determining Sensitivity Gains and Figures of Merit. Limits of detection and limits of quantification were determined for the PBA derivatives of each of the seven test sugars using the LC-contained-ESI-MS/MS method (see Table 3). Nanomolar (nM) LODs were observed for nearly all sugars, with the exception of raffinose, which was in the picomolar range. Using only 1 μL injection, these values equate to femtomole and even sub-femtomole LODs on-column. For comparison, limits of detection were also determined for the underivatized analytes using a conventional ESI source (Table 3). LODs for the underivatized analytes were generally in the micromolar (μM) to high nanomolar range, thus demonstrating a 5-fold to 86-fold improvement in sensitivity for the test sugars using in-source droplet-based PBA derivatization. Gains in sensitivity are the result of both enhanced ionization after derivatization as well abundant product ion formation during CID, allowing the use of SRM analysis which typically affords much better S/N. With the exception of sucrose and raffinose, the underivatized sugars did not generate abundant product ions and so SIM acquisition was the more sensitive mode of analysis.

TABLE 3
Calibration curves, limits of detection (LOD), and limits of quantification (LOQ) for
the set of mono-, di-, and oligosaccharides both with and without derivatization.

| | PBA-Derivative | | | | | | Un- | |
|---|---|---|---|---|---|---|---|---|
| | LOD nM | LOQ | Linear | | Curve | | derivatized | LOD |
| Analyte | (fmol) | nM | Range nM | R² | weighting | Response | LOD^{β} nM | improvement |
| Fructose | 11 | 32 | 32-3200 | 0.997 | 1/x | Normalized | 905 | 82-fold |
| | (11) | | | | | area^{α} | | |
| Glucose | 13 | 37 | 37-3700 | 0.993 | 1/x² | Normalized | 490 | 38-fold |
| | (13) | | | | | area^{α} | | |
| Sucrose | 11 | 30 | 30-3000 | 0.994 | 1/x² | Absolute | 310 | 28-fold |
| | (11) | | | | | area | | |
| Lactose | 197 | 560 | 560-56000 | 0.993 | 1/x² | Absolute | 3825 | 19-fold |
| | (197) | | | | | area | | |
| Raffinose | 0.44 | 1.3 | 1.3-130 | 0.992 | 1/x² | Absolute | 38 | 86-fold |
| | (0.44) | | | | | area | | |
| Gluc₄ | 33 | 94 | 94-9400 | 0.999 | None | Absolute | 510 | 15-fold |
| | (33) | | | | | area | | |
| maltopentaose | 91 | 258 | 258-25800 | 0.996 | none | Absolute | 470 | 5-fold |
| | (91) | | | | | area | | |

^{α}Internal standard = ¹³C₆-glucose
^{β}Underivatized LOD determined using commercial HESI ion source

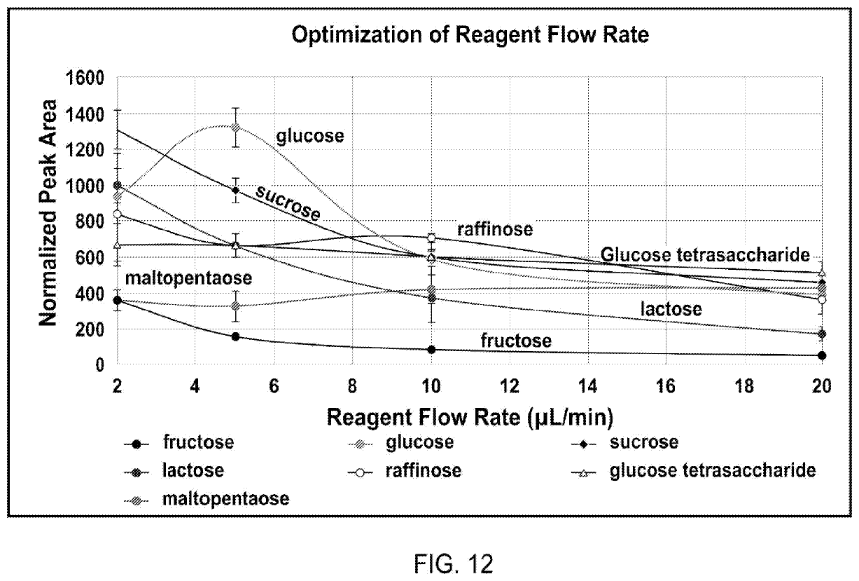

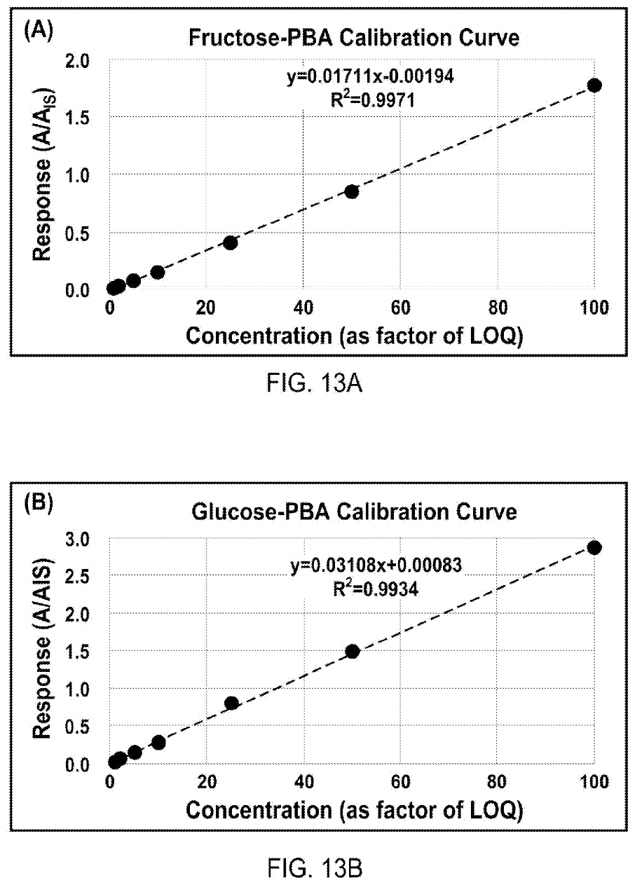

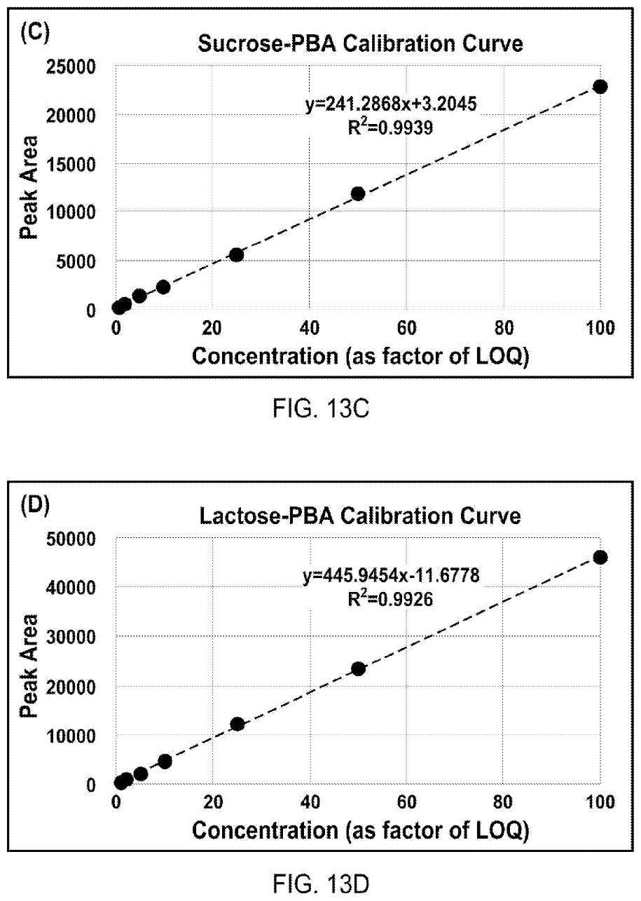

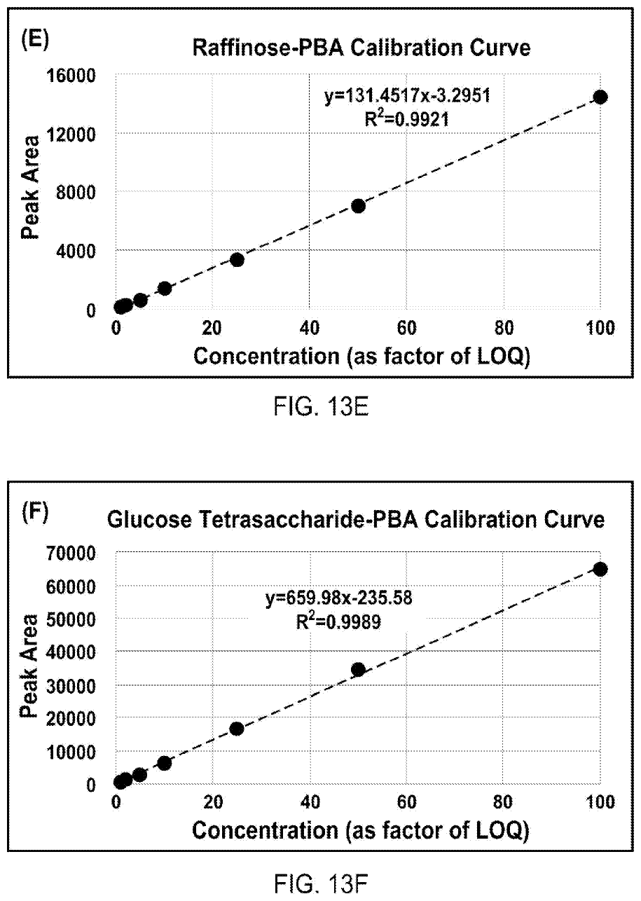

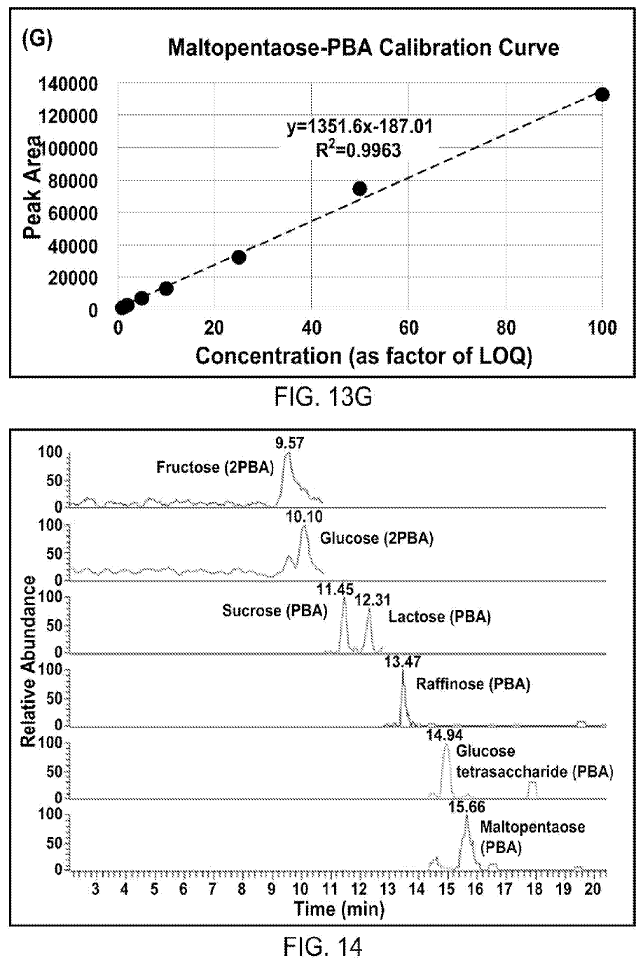

The calculated LOQs were used to construct calibration curves for each of the sugars (FIG. 12). Example chromatograms for a 1×LOQ calibration standard are shown in FIG. 13A-FIG. 13G. In all cases, the curves were linear (R²≥0.99) over a range of at least two orders of magnitude (1× to 100×LOQ). Notably, carryover was not observed as no peaks were detected in the system blanks (clean solvent) analyzed directly after the highest calibrator. For the two monosaccharides, the internal standard was particularly valuable in improving curve fit and correcting for injection-to-injection variability. The internal standard was found to be less useful for the di- and oligosaccharides. As mentioned previously, the reaction proceeds slightly different for monosaccharides than for higher-order saccharides in that monosaccharides preferably generate the disubstituted derivative during reaction while other sugars produce the monosubstituted analog. It may be beneficial to also include an isotopically-labeled di- or oligosaccharide during analysis to normalize variability for these sugars.

The quantitative precision and accuracy of the LC-contained-ESI-MS/MS method were also evaluated (Table 4). Accuracy was found to be acceptable at both low (2×LOQ) and high (50×LOQ) concentrations, exhibiting deviations of less than 7% from nominal in most cases and less than 12% in all cases. Inter-day precision was satisfactory as represented by percent relative standard deviations (% RSDs) generally less than 10% at both the low and high concentrations evaluated. Intra-day precision evaluated at a 10×LOQ concentration was also very good, exhibiting % RSDs of 12% or less across thirteen replicates analyzed over multiple days.

TABLE 4
Accuracy and precision of the LC-contained-ESI-MS/MS method.

| | |
|---|---|
| Accuracy | Precision (% RSD) |

| | (% Dev.) | Inter-day | Intra-day |
|---|---|---|---|
| | 2x/50x LOQ | 2x/50x LOQ | 10x LOQ |
| Analyte | n = 6 each | n = 6 each | n = 13 |
| Fructose | 8.5/1.9 | 11/6.4 | 12 |
| Glucose | 10/11 | 11/9.0 | 12 |
| Sucrose | 6.6/2.6 | 5.6/4.2 | 6.8 |
| Lactose | 1.1/1.7 | 4.4/3.7 | 4.7 |
| Raffinose | 6.5/0.4 | 8.3/7.8 | 8.2 |
| Gluc₄ | 2.6/7.8 | 11/7.4 | 7.5 |
| maltopentaose | 0.7/6.4 | 8.6/8.6 | 6.8 |

Targeted Analysis of Oligosaccharides in Human Urine and Plasma. Glycogen storage disorders (GSDs) are rare metabolic disorders caused by mutations in a gene responsible for the enzyme acid α-glucosidase. Symptomology varies depending on many factors including age of onset, but if left untreated, these disorders can prove fatal. Clinical diagnosis and treatment monitoring currently rely on enzymatic activity assays on tissue samples that require invasive biopsies (Young S P et al. Am. J. Med. Genet. C. 2012, 160C, 50-58). However, new ESI-MS and LC-ESI-MS approaches are being investigated as less-invasive, confirmatory approaches for diagnosis by monitoring changes in the oligosaccharide profile in urine and plasma. Other areas of development focus on targeted analysis for specific biomarkers, such as glucose tetrasaccharide in glycogen storage disease Type II, otherwise known as Pompe disease. Many of the current approaches rely on benchtop derivatizations needing elevated temperatures and reaction times of hours or days, and which require solid-phase extraction (SPE) or liquid-liquid extraction to remove excess reagent prior to analysis. Further, the reported derivatization reactions are only selective for reducing sugars.

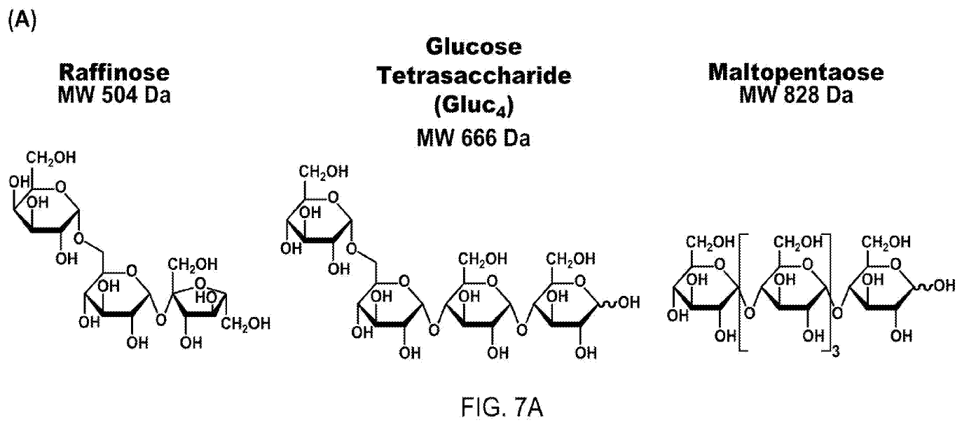

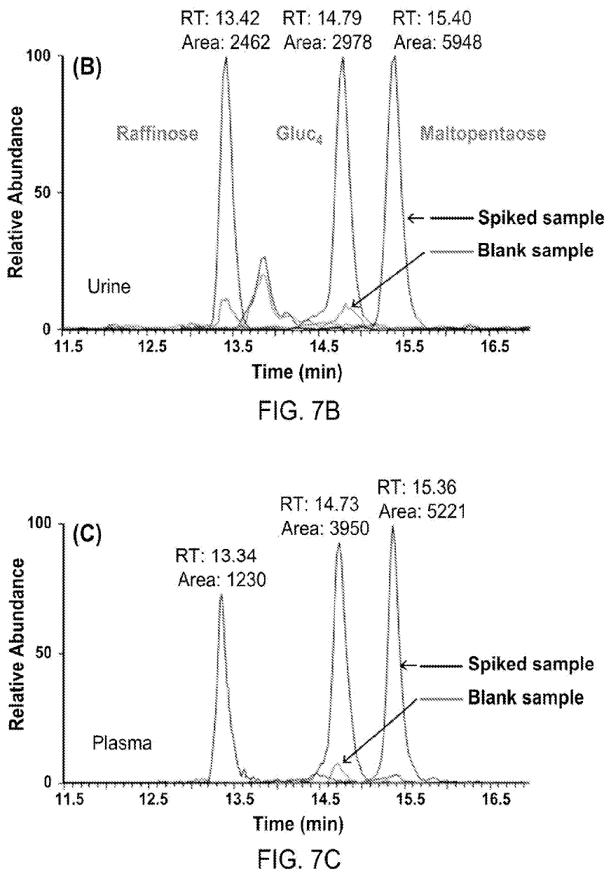

The potential of the LC-contained-ESI-MS/MS method for the analysis of three oligosaccharides—the non-reducing sugar raffinose (M3) as well as the reducing sugars glucose tetrasaccharide (M4) and maltopentaose (M5)-in human urine and plasma was evaluated. Chromatograms representing spiked (10×LOQ) and blank (unspiked) aliquots for both urine and plasma matrices are shown in FIG. 7A-FIG. 7C. For both biofluids samples, significant peaks were observed in the spiked samples for all three oligosaccharides in comparison with the control matrices, evidence that the method is capable of detecting these important biomarkers in complex physiological samples. Small detections for raffinose and glucose tetrasaccharide in the blank, unspiked matrices was expected, as these are endogenous compounds, and show the method is capable of detecting these compounds at bioanalytically-relevant concentrations. In fact, the calculated LOD for glucose tetrasaccharide (33 nM) using the method is significantly lower than LODs reported previously (310-2800 nM) for targeted LC-MS/MS methods, and required only minimal sample cleanup (Bennett R et al. Anal. Chim. Acta 2017, 960, 151-159; Rozaklis T et al. Clin. Chem. 2002, 48(1), 131-139; Piraud M et al. Mol. Genet. Metab. 2020, 23, 100583; Manwaring V et al. J. Inherit. Metab. Dis. 2012, 35, 311-316).

Conclusions. A platform is reported herein that combines chromatographic separation and mass spectrometric detection with online, microdroplet-based in-source derivatization. The enhanced reaction kinetics afforded by desolvating electrospray microdroplets allows derivatization to be carried out in real-time during the ionization process. This approach offers a much simpler and faster alternative to traditional resource-intensive benchtop derivatization protocols and can be automated to improve sample throughput.

In this work, the LC-contained-ESI-MS/MS platform was employed to enhance method sensitivity for mono-, di-, and oligosaccharides using phenylboronic acid derivatization, improving limits of detection greater than 15-fold for six of the seven sugars tested and greater than 80-fold for two of the sugars. The method was found to be sufficiently accurate and precise for routine analysis and exhibited linear ranges of at least two orders of magnitude for all of the sugars tested. The addition of HPLC prior to in-source droplet-based reaction allowed for the sensitive analysis of oligosaccharides in complex physiological samples with very little sample preparation. In addition, the chromatographic separation provides another means of distinguishing isobaric species, as demonstrated here for both monosaccharides (fructose, glucose) and disaccharides (sucrose, lactose).

The post-column arrangement provides some key benefits in addition to the inherent simplicity and potential for automation. Because the reaction occurs after the separation process is complete, the potential for adverse chromatographic effects caused by the reagent/modifier are eliminated. Further, placing the derivatization step after the separation imparts more confidence in the final analytical results because the orthogonal information acquired during analysis represents both the derivatized analyte (e.g., precursor ion, product ion) and the native, underivatized analyte (e.g., retention time). Conventional benchtop (pre-HPLC) derivatization only acquires information characteristic of the derivatized species and provides no means of determining whether the true analyte was present in the sample.

The LC-contained-ESI-MS setup described herein can be used to carry out a wide range of alternative reactions to enhance analysis sensitivity and specificity for other compounds that present analytical challenges.

### Example 2—Co-Axial Multi-Modal Contained Electrospray for Coupling Accelerated Droplet Reaction to Liquid Chromatography-Mass Spectrometry

Recent developments have transformed mass spectrometry (MS) into an all-purpose technique for in-situ and real-time chemical analysis, but quantitative mass spectrometry is beset with challenges posed by ion suppression effects due to the presence of endogenous or exogenous matrices. This research aims to fundamentally advance analytical mass spectrometry by developing methods that combine ion generation and reaction into a single step.

The underlying principle is based on the following hypothesis: that because most mechanisms related to ion suppression in electrospray ionization (ESI) mass spectrometry (e.g., competition for charge and space) occur in the charged droplet environment, it is necessary to develop methods that overcome ion suppression during the stages of the droplet or ion formation (not before, and not after). The accelerated reaction rates, typical under the confined droplet reaction conditions, make possible rapid and efficient chemical detection. The apparatus is capable of both ground-state and excited-state chemistry, which can be applied either to enhance chemical detection or enable isomer differentiation. The apparatus to droplet chemistry itself is the ion source so no instrumental modifications are needed.

A co-axial contained electrospray ionization platform has been developed that can be operated in multiple modes to tune droplet reactivity for various analytes (e.g., proteins, lipids, fatty acids, and organic compounds). The new platform can be coupled to any type of liquid chromatography (LC) to allow online modification of compounds eluding from the liquid chromatography column before entering the mass spectrometer. No solution-phase analyte is needed, something that typically requires long reaction times. The liquid chromatography mobile phase need not be modified with reactive reagents to enhance ionization. When using the co-axial contained-ESI, reactive reagents are supplied after the separation process is done. This is important because the preferred liquid chromatography mobile phase composition is not always suited for ESI. For example, organic acids that are often added to liquid chromatography mobile phases to promote ESI ionization prohibit the separation and analysis of weakly bound protein complexes on LC-MS systems due to possible protein denaturation. This technical challenge is solved herein through the introduction of reagents during the stages of the droplet formation.

The apparatus is also capable of plasma-droplet fusion that can be activated as part of the electrospray process. That is, the plasma is created during the wake of the charged microdroplets at >3 kV spray voltages. This allows both polar and non-polar analytes to be effectively detected. This plasma-droplet fusing experiment is important because no chromophores are needed to perform excited-state chemistry.

Electron collisions in the droplet environment provides a universal energy source to excite any type of analyte. The presence of solvents allows selective chemical reactions without any unwanted fragmentation.

In this report, various aspects of the contained-ESI source are described, including its coupling to liquid chromatography. Then its application for a variety of chemical reactions is presented, including 1) enhanced saccharide detection via reaction with phenylboronic acid, 2) enzyme catalyzed lipid hydrolysis, which can be generalized for any enzymatic reactions, 3) online localization of C═C bonds in lipids and free fatty acids via both plasma-droplet fusion and photo-induced Patemo-Buchi reaction, 4) steroid analysis via reaction with Girard T reagent, and 5) online protein cross-linking. All these reactions can be coupled with LC-MS analyses.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The devices and methods of the appended claims are not limited in scope by the specific devices and methods described herein, which are intended as illustrations of a few aspects of the claims and any devices and methods that are functionally equivalent are intended to fall within the scope of the claims. Various modifications of the devices and methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. An electrospray emitter device comprising:
a sample capillary extending from a sample inlet to a sample outlet said sample capillary defining a path for fluid flow from the sample inlet to the sample outlet;
wherein the sample inlet is configured to receive a fluid sample, the fluid sample being an eluent from a liquid chromatograph;
a reagent capillary extending from a reagent inlet to a reagent outlet, the reagent capillary defining a path for fluid flow from the reagent inlet to the reagent outlet;
wherein the reagent inlet is configured to receive a fluid reagent;
a voltage source conductively coupled to the reagent capillary and configured to apply a voltage to the reagent capillary;
a first conduit disposed around a first portion of the sample capillary and a first portion of the reagent capillary,
the first conduit comprising a wall defining a lumen;
the first conduit extending from a first end to a second end opposite and axially spaced apart from the first end;
the lumen defining a path for fluid flow;
a carrier gas inlet fluidly connected to the lumen, the carrier gas inlet being configured to receive a carrier gas;
wherein the sample outlet and the reagent outlet each extend beyond the second end of the first conduit such that the sample outlet and the reagent outlet are each disposed outside of the first conduit.

2. The electrospray emitter device of claim 1, wherein the carrier gas inlet is integrally formed with the first conduit.

3. The electrospray emitter device of claim 1 or claim 2, further comprising a carrier gas source fluidly connected to the carrier gas inlet.

4. The electrospray emitter device of any one of claims 1-3, further comprising:
a first fitting disposed within the lumen of the first conduit towards the first end, the first fitting being coaxial with the first conduit;
the first fitting being fluid tight and having a one or more ports configured to receive the sample capillary and the reagent capillary, such that the sample capillary and the reagent capillary each penetrate through the first fitting.

5. The electrospray emitter device of claim 4, wherein the first fitting comprises a first port configured to receive the sample capillary and a second port configured to receive the reagent capillary.

6. The electrospray emitter device of any one of claims 1-5, further comprising:
a second conduit disposed around a second portion of the sample capillary and a second portion of the reagent capillary;
the second conduit comprising a wall defining a lumen;
the second conduit extending from a proximal end to a distal end opposite and axially spaced apart from the proximal end;
the lumen defining a path for fluid flow terminating in a gas outlet at the distal end;
wherein the proximal end of the second conduit is disposed within the lumen of the first conduit and the distal end of the second conduit extends beyond the second end of the first conduit, such that the first conduit is disposed around a portion of the second conduit and the distal end of the second conduit is disposed outside of the first conduit;
wherein the sample outlet and the reagent outlet each extend beyond the distal end of the second conduit such that the sample outlet and the reagent outlet are each disposed outside of the second conduit.

7. The electrospray emitter device of claim 6, further comprising:
a second fitting disposed within the lumen of the first conduit towards the second end, the second fitting being coaxial with the first conduit;
the second fitting having an orifice configured to receive the second conduit such that the second conduit penetrates through the second fitting and the second fitting is disposed around a portion of the second conduit;
wherein the second fitting forms a fluid tight seal extending between the first conduit and the second conduit.

8. An electrospray emitter device comprising:
a sample capillary extending from a sample inlet to a sample outlet, said sample capillary defining a path for fluid flow from the sample inlet to the sample outlet;
wherein the sample inlet is configured to receive a fluid sample, the fluid sample being an eluent from a liquid chromatograph;
a reagent capillary extending from a reagent inlet to a reagent outlet, the reagent capillary defining a path for fluid flow from the reagent inlet to the reagent outlet;
wherein the reagent inlet is configured to receive a fluid reagent;
a voltage source conductively coupled to the reagent capillary and configured to apply a voltage to the reagent capillary;
a first conduit disposed around a first portion of the sample capillary and a first portion of the reagent capillary;
the first conduit comprising a wall defining a lumen;
the first conduit extending from a first end to a second end opposite and axially spaced apart from the first end;
the lumen defining a path for fluid flow;
a carrier gas inlet fluidly connected to the lumen, the carrier gas inlet being configured to receive a carrier gas;
a second conduit disposed around a second portion of the sample capillary and a second portion of the reagent capillary;
the second conduit comprising a wall defining a lumen;
the second conduit extending from a proximal end to a distal end opposite and axially spaced apart from the proximal end;
the lumen defining a path for fluid flow terminating in a gas outlet at the distal end;
wherein the proximal end of the second conduit is disposed within the lumen of the first conduit and the distal end of the second conduit extends beyond the second end of the first conduit, such that the first conduit is disposed around a portion of the second conduit and the distal end of the second conduit is disposed outside of the first conduit;
wherein the sample outlet and the reagent outlet each extend beyond the distal end of the second conduit such that the sample outlet and the reagent outlet are each disposed outside of the second conduit;
a first fitting disposed within the lumen of the first conduit towards the first end, the first fitting being coaxial with the first conduit;
the first fitting being fluid tight and having a one or more ports configured to receive the sample capillary and the reagent capillary, such that the sample capillary and the reagent capillary each penetrate through the first fitting;
a second fitting disposed within the lumen of the first conduit towards the second end, the second fitting being coaxial with the first conduit;
the second fitting having an orifice configured to receive the second conduit such that the second conduit penetrates through the second fitting and the second fitting is disposed around a portion of the second conduit; and
wherein the second fitting forms a fluid tight seal extending between the first conduit and the second conduit.

9. The electrospray emitter device of claim 8, wherein the first fitting comprises a first port configured to receive the sample capillary and a second port configured to receive the reagent capillary.

10. The electrospray emitter device any one of claims 1-9, further comprising a liquid chromatograph fluidly coupled to the sample inlet, such that the liquid chromatograph is configured to inject the fluid sample into the sample inlet.

11. The electrospray emitter device of any one of claims 1-10, wherein the sample capillary comprises a section disposed between the sample inlet and the first end of the first conduit, and said section being grounded.

12. The electrospray emitter device of claim 11, wherein the section is conductively coupled to a ground source.

13. The electrospray emitter device of claim 11 or claim 12, wherein the section comprises PEEK.

14. The electrospray emitter device of any one of claims 1-13, wherein the sample capillary has an average internal diameter of from 50 microns to 200 microns.

15. The electrospray emitter device of any one of claims 1-14, wherein the sample capillary has an average internal diameter of 100 microns.

16. The electrospray emitter device of any one of claims 1-15, wherein the sample capillary comprises fused silica.

17. The electrospray emitter device of any one of claims 1-16, wherein the reagent inlet is fluidly coupled to a reagent source.

18. The electrospray emitter device of claim 17, further comprising a pump fluidly connected to the reagent source and the reagent inlet, the pump being configured to inject the fluid reagent into the reagent inlet.

19. The electrospray emitter device of any one of claims 1-18, wherein the reagent capillary has an average internal diameter of from 50 microns to 200 microns.

20. The electrospray emitter device of any one of claims 1-19, wherein the reagent capillary has an average internal diameter of 100 microns.

21. The electrospray emitter device of any one of claims 1-20, wherein the reagent capillary comprises fused silica.

22. The electrospray emitter device of any one of claims 1-21, wherein the first conduit comprises stainless steel.

23. The electrospray emitter device of any one of claims 6-22, wherein the second conduit has an average internal diameter of from 200 microns to 1000 microns.

24. The electrospray emitter device of any one of claims 6-23, wherein the second conduit has an average internal diameter of 450 microns.

25. The electrospray emitter device of any one of claims 6-24, wherein the second conduit comprises fused silica.

26. The electrospray emitter device of any one of claims 1-25, wherein the electrospray emitter device further comprises an analyzer positioned to receive an electrosprayed sample from the sample outlet and the reagent outlet.

27. The electrospray emitter device of claim 26, wherein the analyzer comprises a mass spectrometer.

28. A method of use of the electrospray emitter device of any one of claims 1-27, the method comprising:
injecting a fluid sample into the sample inlet and injecting a fluid reagent into the reagent inlet;
forming a droplet of the fluid sample at the sample outlet and forming a droplet of the fluid reagent at the reagent outlet;
injecting a carrier gas into the carrier gas inlet, thereby contacting the droplet of the fluid sample and the droplet of the fluid reagent with the carrier gas; and
ejecting the droplet of the fluid sample from the sample outlet and ejecting the droplet of the fluid reagent from the reagent outlet.

29. The method of claim 28, wherein the fluid sample comprises a solvent and an analyte.

30. The method of claim 29, wherein the solvent comprises acetonitrile, water, or a combination thereof.

31. The method of any one of claims 28-30, wherein the fluid sample comprises a bodily fluid, such as urine, plasma, or a combination thereof.

32. The method of claim 31, wherein the bodily fluid comprises a saccharide, a lipid, a fatty acid, a steroid, a protein, a nucleic acid, or a combination thereof.

33. The method of any one of claims 29-32, wherein the analyte comprises a saccharide, a lipid, a fatty acid, a steroid, a protein, a nucleic acid, or a combination thereof.

34. The method of any one of claims 28-33, wherein the fluid sample is injected at a flow rate of from 1 μL/minute to 100 μL/minute.

35. The method of any one of claims 28-34, wherein the fluid sample is injected at a flow rate of 75 μL/minute.

36. The method of any one of claims 28-35, wherein the fluid sample is injected from a liquid chromatograph.

37. The method of any one of claims 28-36, wherein the carrier gas comprises nitrogen.

38. The method of any one of claims 28-37, wherein the carrier gas is injected at a pressure of from 0 to 150 psi.

39. The method of any one of claims 28-38, wherein the voltage applied to the reagent capillary is from 0 kV to 10 kV.

40. The method of any one of claims 28-39, wherein the voltage applied to the reagent capillary is 6.5 kV.

41. The method of any one of claims 28-40, wherein ejecting the droplets comprises adjusting a pressure at which the carrier gas is injected, adjusting a flow rate at which the fluid sample is injected, adjusting the flow rate at which the fluid reagent is injected, adjusting the voltage applied to the sample capillary, or a combination thereof.

42. The method of any one of claims 28-41, wherein the fluid reagent is injected at a flow rate of from 1 μL/minute to 20 μL/minute.

43. The method of any one of claims 28-42, wherein the fluid reagent is injected at a flow rate of 5 μL/minute.

44. The method of any one of claims 28-43, wherein the fluid reagent comprises a solvent and a reagent.

45. The method of claim 44, wherein the solvent comprises acetonitrile, water, or a combination thereof.

46. The method of claim 44 or claim 45, wherein the reagent has a concentration of from greater than 0 mM to 100 mM.

47. The method of any one of claims 44-46, wherein the reagent has a concentration of 4 mM.

48. The method of any one of claims 28-47, wherein the ejected droplet of the fluid sample comprises an ionized form of the analyte.

49. The method of any one of claims 28-48, wherein the ejected droplet of the fluid reagent comprises an ionized form of the reagent.

50. The method of any one of claims 28-49, wherein the ejected droplet of the fluid sample contacts and reacts with the ejected droplet of the fluid reagent, thereby forming one or more droplets comprising a reacted sample.

51. The method of any one of claims 28-50, wherein the ejected droplet of the fluid sample and the ejected droplet of the fluid reagent form a single Taylor cone.

52. The method of any one of claims 28-51, wherein the reagent comprises a derivatization reagent, a hydrolysis reagent, a catalytic reagent, a crosslinking reagent, an adduct forming reagent, or a combination thereof.

53. The method of any one of claims 28-52, wherein the reacted sample comprises a derivatized form of the analyte.

54. The method of any one of claims 28-53, wherein the reaction is achieved on a timescale similar to electrospray microdroplet lifetimes.

55. The method of any one of claims 28-54, wherein the reaction is achieved in an amount of time from 1 microsecond to 1 minute.

56. The method of any one of claims 28-55, wherein the reaction is achieved in an amount of time from 1 microsecond to 30 seconds, or from 1 microsecond to 10 seconds.

57. The method of any one of claims 28-56, further comprising collecting one or more of the one or more droplets comprising the reacted sample.

58. The method of any one of claims 28-57, further comprising injecting one or more of the one or more droplets comprising the reacted sample into an analyzer.

59. The method of claim 58, wherein the analyzer comprises a mass spectrometer.
